(19) United States
(12) Patent Application Publication
(10) Pub. No.: US 2026/0086643 A1
(43) Pub. Date: Mar. 26, 2026

(54) VIRTUAL INTERSECTION HAPTIC FEEDBACK FOR ELECTRONIC POINTING DEVICES

(71) Applicant: Apple Inc., Cupertino, CA (US)

(72) Inventors: Benjamin R. BLACHNITZKY, San Francisco, CA (US); Arun Rakesh YOGANANDAN, San Francisco, CA (US); Nicolai GEORG, San Francisco, CA (US); Carmine ELVEZIO, San Francisco, CA (US); Matthew J. SUNDSTROM, Campbell, CA (US)

(21) Appl. No.: 19/297,969

(22) Filed: Aug. 12, 2025

Related U.S. Application Data
(60) Provisional application No. 63/699,127, filed on Sep. 25, 2024.

(51) Int. Cl. G06F 3/01; G06F 3/0346

(52) U.S. Cl. CPC G06F 3/016; G06F 3/0346

(57) ABSTRACT

Some examples of the disclosure are directed to systems and methods for generating a haptic feedback response at an electronic pointing device based on virtual intersections between a simulated tool and virtual content. In one or more examples, an electronic device (e.g., computing system) has an electronic input device that is communicatively coupled (e.g., wired and/or wirelessly) to the electronic device and is configured to receive commands from the electronic to generate haptic feedback (e.g., vibration) patterns based on characteristics of the simulated tool and/or the virtual content that present a virtual intersection.

### CROSS REFERENCE TO RELATED APPLICATIONS

This application claims the benefit of U.S. Provisional Application No. 63/699,127, filed Sep. 25, 2024, the entire disclosure of which is herein incorporated by reference for all purposes.

### FIELD OF THE DISCLOSURE

This relates generally to systems and methods for generating haptic feedback at an electronic pointing device.

### BACKGROUND OF THE DISCLOSURE

Some computer systems include cameras configured to capture images and/or video. Some computer systems, using the cameras, display three-dimensional environment that include representations of physical real-world objects as well as virtual objects.

### SUMMARY OF THE DISCLOSURE

Some examples of the disclosure are directed to systems and methods for generating a haptic feedback response at an electronic pointing device based on the pose of one or more hands of the user. In one or more examples, an electronic device (e.g., computing system) has an electronic pointing device that is communicatively coupled (e.g., wired and/or wirelessly) to the electronic device and is configured to receive commands from the electronic device to generate haptic feedback (e.g., vibration) patterns. In one or more examples, the electronic pointing device can correspond to a virtual tool, and when the virtual tool intersects with a virtual object, the electronic pointing device can generate haptic feedback indicating the intersection to user of the electronic device.

In some examples, the electronic device can display virtual content that includes a virtual surface and/or texture. In some examples, the electronic device can display a representation of a tool, at times referred to herein as a simulated tool, extending from an electronic pointing device. In some examples, the electronic device can detect and/or receive an indication of movement the electronic pointing device. In some examples, in response to detecting the indication of the movement, the electronic device can move the simulated tool. In some examples, when the movement of the simulated tool causes a volume that corresponds to the simulated tool to overlap with and/or intersect with a volume corresponding to the virtual object, the electronic device can cause the electronic pointing device to generate haptic feedback.

In some examples, one or more characteristics of the haptic feedback are generated based upon a degree of the virtual intersection. In some examples, the degree of virtual intersection includes the amount of overlap and/or intersection between the simulated tool and the virtual content. In some examples, the one or more characteristics include an amplitude, frequency content, timing, pattern, and/or spatial distribution of the haptic feedback. In some examples, the one or more characteristics are based on the virtual kinematics of the simulated tool including a particular speed, velocity, and/or acceleration. In some examples, the one or more characteristics are based upon characteristics of the virtual object that intersect with the simulated tool. In some examples, the one or more characteristics of the virtual object includes a surface texture and/or contents of the virtual object. In some examples, the one or more characteristics of the haptic feedback are generated based on a size of the simulated tool. In some examples, the one or more characteristics of the haptic feedback are generated based on an orientation of the simulated tool relative to the virtual object.

### BRIEF DESCRIPTION OF THE DRAWINGS

For improved understanding of the various examples described herein, reference should be made to the Detailed Description below along with the following drawings. Like reference numerals often refer to corresponding parts throughout the drawings.

FIG. 1 illustrates an electronic device presenting an extended reality environment according to some examples of the disclosure.

FIG. 2A illustrates a block diagram of an example architecture for a device according to some examples of the disclosure.

FIG. 2B illustrates a block diagram of an example architecture for an electronic pointing device according to some examples.

FIGS. 3A-3N illustrate an example system and method for generating haptic effects on an electronic pointing device based on virtual intersections according to some examples of the disclosure.

FIG. 4 illustrates an example flow diagram illustrating a method of generating haptic effects on an electronic pointing device based on virtual intersections according to some examples of the disclosure.

### DETAILED DESCRIPTION

Some examples of the disclosure are directed to systems and methods for generating a haptic feedback response at an electronic pointing device based on the pose of one or more hands of the user. In one or more examples, an electronic device (e.g., computing system) has an electronic pointing device that is communicatively coupled (e.g., wired and/or wirelessly) to the electronic device and is configured to receive commands from the electronic device to generate haptic feedback (e.g., vibration) patterns. In one or more examples, the electronic pointing device can correspond to a virtual tool, and when the virtual tool intersects with a virtual object, the electronic pointing device can generate haptic feedback indicating the intersection to the user of the electronic device.

In some examples, the electronic device can display virtual content that includes a virtual surface and/or texture. In some examples, the electronic device can display a representation of a tool, at times referred to herein as a simulated tool, extending from an electronic pointing device. In some examples, the electronic device can detect and/or receive an indication of movement the electronic pointing device. In some examples, in response to detecting the indication of the movement, the electronic device can move the simulated tool. In some examples, when the movement of the simulated tool causes a volume that corresponds to the simulated tool to overlap with and/or intersect with a volume corresponding to the virtual object, the electronic device can cause the electronic pointing device to generate haptic feedback.

In some examples, one or more characteristics of the haptic feedback are generated based upon a degree of the virtual intersection. In some examples, the degree of virtual intersection includes the amount of overlap and/or intersection between the simulated tool and the virtual content. In some examples, the one or more characteristics include an amplitude, frequency content, timing, pattern, and/or spatial distribution of the haptic feedback. In some examples, the one or more characteristics are based on the virtual kinematics of the simulated tool including a particular speed, velocity, and/or acceleration. In some examples, the one or more characteristics are based upon characteristics of the virtual object that intersects with the simulated tool. In some examples, the one or more characteristics of the virtual object includes a surface texture and/or contents of the virtual object. In some examples, the one or more characteristics of the haptic feedback are generated based on a size of the simulated tool. In some examples, the one or more characteristics of the haptic feedback are generated based on an orientation of the simulated tool relative to the virtual object.

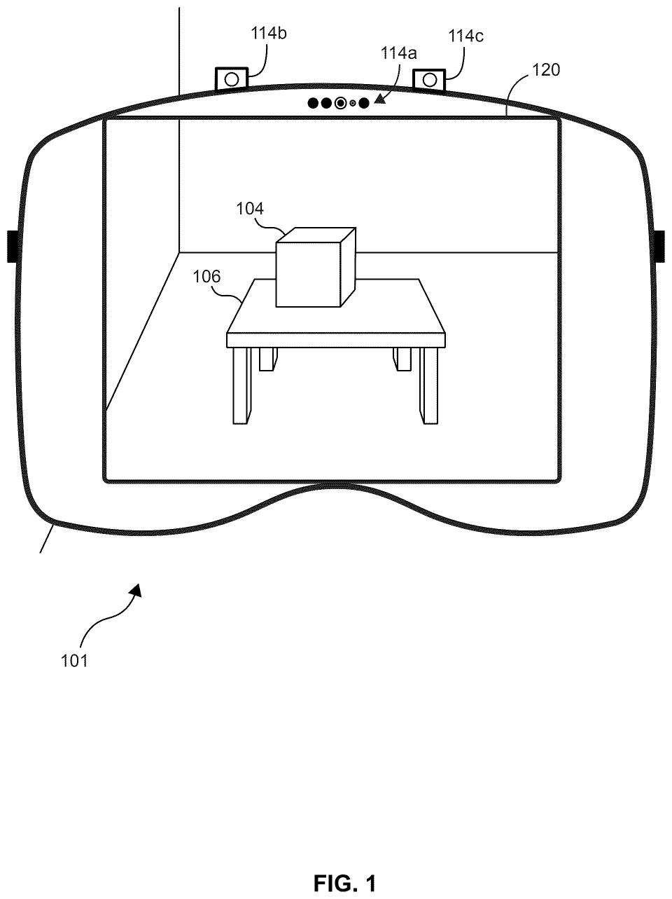

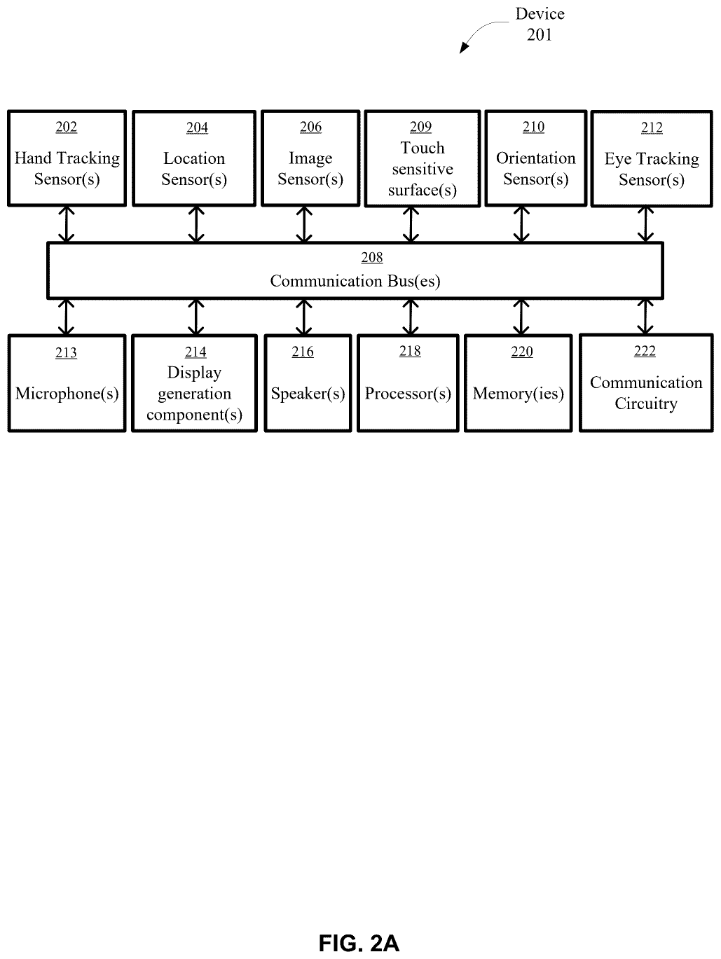

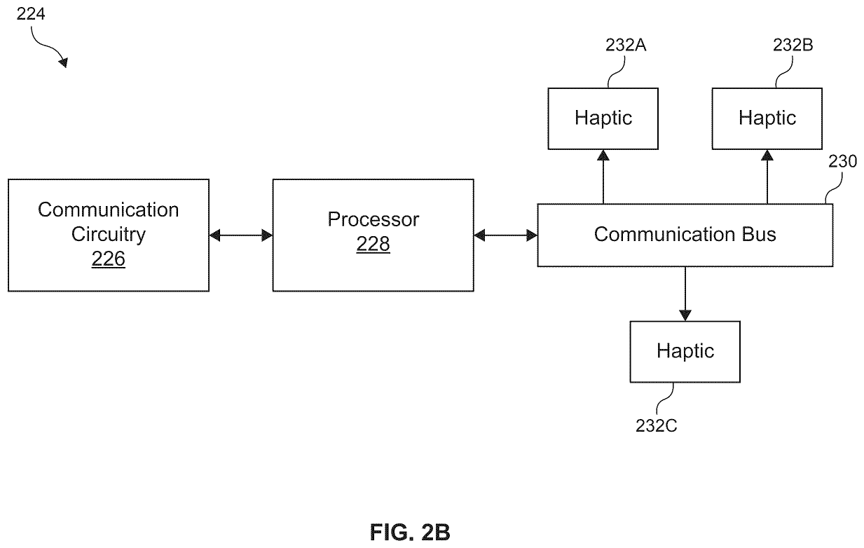

FIG. 1 illustrates an electronic device 101 presenting an extended reality (XR) environment (e.g., a computer-generated environment optionally including representations of physical and/or virtual objects) according to some examples of the disclosure. In some examples, as shown in FIG. 1, electronic device 101 is a head-mounted display or other head-mountable device configured to be worn on a head of a user of the electronic device 101. Additionally or alternatively, electronic device 101 can be any computing system (such as a mobile phone) in which one or more cameras produce images of the environment of the user and can superimpose virtual objects onto a displayed environment. Examples of electronic device 101 are described below with reference to the architecture block diagram of FIG. 2A. As shown in FIG. 1, electronic device 101 and table 106 are located in a physical environment. The physical environment may include physical features such as a physical surface (e.g., floor, walls) or a physical object (e.g., table, lamp, etc.). In some examples, electronic device 101 may be configured to detect and/or capture images of physical environment including table 106 (illustrated in the field of view of electronic device 101).

In some examples, as shown in FIG. 1, electronic device 101 includes one or more internal image sensors 114a oriented towards a face of the user (e.g., eye tracking cameras described below with reference to FIG. 2A). In some examples, internal image sensors 114a are used for eye tracking (e.g., detecting a gaze of the user). Internal image sensors 114a are optionally arranged on the left and right portions of display 120 to enable eye tracking of the user's left and right eyes. In some examples, electronic device 101 also includes external image sensors 114b and 114c facing outwards from the user to detect and/or capture the physical environment of the electronic device 101 and/or movements of the user's hands or other body parts.

In some examples, display 120 has a field of view visible to the user (e.g., that may or may not correspond to a field of view of external image sensors 114b and 114c). Because display 120 is optionally part of a head-mounted device, the field of view of display 120 is optionally the same as or similar to the field of view of the user's eyes. In some examples, the field of view visible to the user is different from a field of view of external image sensors 114b and 114c (e.g., narrower than the field of view of external image sensors 114b and 114c). In other examples, the field of view of display 120 may be smaller than the field of view of the user's eyes. In some examples, electronic device 101 may be an optical see-through device in which display 120 is a transparent or translucent display through which portions of the physical environment may be directly viewed. In some examples, display 120 may be included within a transparent lens and may overlap all or only a portion of the transparent lens. In other examples, electronic device 101 may be a video-passthrough device in which display 120 is an opaque display configured to display images of the physical environment captured by external image sensors 114b and 114c. While a single display 120 is shown, it should be appreciated that display 120 may include a stereo pair of displays.

In some examples, in response to a trigger, the electronic device 101 may be configured to display a virtual object 104 in the XR environment represented by a cube illustrated in FIG. 1, which is not present in the physical environment, but is displayed in the XR environment positioned on the top of a real-world table, such as table 106 (or a representation thereof). Optionally, virtual object 104 can be displayed on the surface of the table 106 in the three-dimensional environment displayed via the display 120 of the electronic device 101 in response to detecting the planar surface of table 106 in the physical environment 100.

In some examples, the display 120 is provided as a passive component (e.g., rather than an active component) within electronic device 101. For example, the display 120 may be a transparent or translucent display, as mentioned above, and may not be configured to display virtual content (e.g., images of the physical environment captured by external image sensors 114b and 114c and/or virtual object 104). Alternatively, in some examples, the electronic device 101 does not include the display 120. In some such examples in which the display 120 is provided as a passive component or is not included in the electronic device 101, the electronic device 101 may still include sensors (e.g., internal image sensor 114a and/or external image sensors 114b and 114c) and/or other input devices, such as one or more of the components described below with reference to FIG. 2A.

It should be understood that virtual object 104 is a representative virtual object and one or more different virtual objects (e.g., of various dimensionality such as two-dimensional or other three-dimensional virtual objects) can be included and rendered in a three-dimensional XR environment. For example, the virtual object can represent an application or a user interface displayed in the XR environment. In some examples, the virtual object can represent content corresponding to the application and/or displayed via the user interface in the XR environment. In some examples, the virtual object 104 is optionally configured to be interactive and responsive to user input (e.g., air gestures, such as air pinch gestures, air tap gestures, and/or air touch gestures), such that a user may virtually touch, tap, move, rotate, or otherwise interact with, the virtual object 104.

In some examples, displaying an object in a three-dimensional environment may include interaction with one or more user interface objects in the three-dimensional environment. For example, initiation of display of the object in the three-dimensional environment can include interaction with one or more virtual options/affordances displayed in the three-dimensional environment. In some examples, a user's gaze may be tracked by the electronic device as an input for identifying one or more virtual options/affordances targeted for selection when initiating display of an object in the three-dimensional environment. For example, gaze can be used to identify one or more virtual options/affordances targeted for selection using another selection input. In some examples, a virtual option/affordance may be selected using hand-tracking input detected via an input device in communication with the electronic device. In some examples, objects displayed in the three-dimensional environment may be moved and/or reoriented in the three-dimensional environment in accordance with movement input detected via the input device.

In the discussion that follows, an electronic device that is in communication with one or more displays and one or more input devices is described. It should be understood that the electronic device optionally is in communication with one or more other physical user-interface devices, such as a touch-sensitive surface, a physical keyboard, a mouse, a joystick, a hand tracking device, an eye tracking device, a stylus, etc. Further, as described above, it is understood that the described electronic device, display and touch-sensitive surface are optionally distributed between two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the computer system, or touch input received on the surface of a stylus) is optionally used to describe input received on a separate input device, from which the computer system receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

FIG. 2A illustrates a block diagram of an example architecture for a device 201 according to some examples of the disclosure. In some examples, device 201 includes one or more computer systems. For example, the electronic device 201 may be a portable device, an auxiliary device in communication with another device, a head-mounted display, etc., respectively. In some examples, electronic device 201 corresponds to electronic device 101 described above with reference to FIG. 1.

As illustrated in FIG. 2A, the electronic device 201 optionally includes various sensors, such as one or more hand tracking sensors 202, one or more location sensors 204, one or more image sensors 206 (optionally corresponding to internal image sensors 114a and/or external image sensors 114b and 114c in FIG. 1), one or more touch-sensitive surfaces 209, one or more motion and/or orientation sensors 210, one or more eye tracking sensors 212, one or more microphones 213 or other audio sensors, one or more body tracking sensors (e.g., torso and/or head tracking sensors), one or more display generation components 214, optionally corresponding to display 120 in FIG. 1, one or more speakers 216, one or more processors 218, one or more memories 220, and/or communication circuitry 222. One or more communication buses 208 and/or communication bus 230 are optionally used for communication between the above-mentioned components of electronic device 201.

Communication circuitry 222 optionally includes circuitry for communicating with computer systems, networks, such as the Internet, intranets, a wired network and/or a wireless network, cellular networks, and wireless local area networks (LANs). Communication circuitry 222 optionally includes circuitry for communicating using near-field communication (NFC) and/or short-range communication, such as Bluetooth®, etc. In some examples, communication circuitry 222A, 222B includes or supports Wi-Fi (e.g., an 802.11 protocol), Ethernet, ultra-wideband (“UWB”), high frequency systems (e.g., 900 MHz, 2.4 GHz, and 5.6 GHz communication systems), or any other communications protocol, or any combination thereof.

Processor(s) 218 include one or more general processors, one or more graphics processors, and/or one or more digital signal processors. In some examples, one or more processors 218 include one or more microprocessors, one or more central processing units, one or more application-specific integrated circuits, one or more field-programmable gate arrays, one or more programmable logic devices, or a combination of such devices. In some examples, memory 220 is a non-transitory computer-readable storage medium (e.g., flash memory, random access memory, or other volatile or non-volatile memory or storage) that stores computer-readable instructions configured to be executed by processor(s) 218 to perform the techniques, processes, and/or methods described below. In some examples, memory 220 can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on compact disc (CD), digital versatile disc (DVD), or Blu-ray technologies, as well as persistent solid-state memory such as flash, solid-state drives, and the like.

In some examples, one or more display generation components 214 include a single display (e.g., a liquid-crystal display (LCD), organic light-emitting diode (OLED), or other types of display). In some examples, display generation component(s) 214 includes multiple displays. In some examples, display generation component(s) 214 can include a display with touch capability (e.g., a touch screen), a projector, a holographic projector, a retinal projector, a transparent or translucent display, etc. In some examples, electronic device 201 includes touch-sensitive surface(s) 209, respectively, for receiving user inputs, such as tap inputs and swipe inputs or other gestures. In some examples, display generation component(s) 214 and touch-sensitive surface(s) 209 form touch-sensitive display(s) (e.g., a touch screen integrated with electronic device 201 or external to electronic device 201 that is in communication with electronic device 201).

Electronic device 201 optionally includes image sensor(s) 206. Image sensors(s) 206 optionally include one or more visible light image sensors, such as charged coupled device (CCD) sensors, and/or complementary metal-oxide-semiconductor (CMOS) sensors operable to obtain images of physical objects from the real-world environment. Image sensor(s) 206 also optionally include one or more infrared (IR) sensors, such as a passive or an active IR sensor, for detecting infrared light from the real-world environment. For example, an active IR sensor includes an IR emitter for emitting infrared light into the real-world environment. Image sensor(s) 206 also optionally include one or more cameras configured to capture movement of physical objects in the real-world environment. Image sensor(s) 206 also optionally include one or more depth sensors configured to detect the distance of physical objects from electronic device 201. In some examples, information from one or more depth sensors can allow the device to identify and differentiate objects in the real-world environment from other objects in the real-world environment. In some examples, one or more depth sensors can allow the device to determine the texture and/or topography of objects in the real-world environment.

In some examples, electronic device 201 uses CCD sensors, event cameras, and depth sensors in combination to detect the physical environment around electronic device 201. In some examples, image sensor(s) 206 include a first image sensor and a second image sensor. The first image sensor and the second image sensor work in tandem and are optionally configured to capture different information of physical objects in the real-world environment. In some examples, the first image sensor is a visible light image sensor and the second image sensor is a depth sensor. In some examples, electronic device 201 uses image sensor(s) 206 to detect the position and orientation of electronic device 201 and/or display generation component(s) 214 in the real-world environment. For example, electronic device 201 uses image sensor(s) 206 to track the position and orientation of display generation component(s) 214 relative to one or more fixed objects in the real-world environment.

In some examples, electronic device 201 includes microphone(s) 213 or other audio sensors. Electronic device 201 optionally uses microphone(s) 213 to detect sound from the user and/or the real-world environment of the user. In some examples, microphone(s) 213 includes an array of microphones (a plurality of microphones) that optionally operate in tandem, such as to identify ambient noise or to locate the source of sound in space of the real-world environment.

Electronic device 201 includes location sensor(s) 204 for detecting a location of electronic device 201 and/or display generation component(s) 214. For example, location sensor(s) 204 can include a global positioning system (GPS) receiver that receives data from one or more satellites and allows electronic device 201 to determine the device's absolute position in the physical world.

Electronic device 201 includes orientation sensor(s) 210 for detecting orientation and/or movement of electronic device 201 and/or display generation component(s) 214. For example, electronic device 201 uses orientation sensor(s) 210 to track changes in the position and/or orientation of electronic device 201 and/or display generation component(s) 214, such as with respect to physical objects in the real-world environment. Orientation sensor(s) 210 optionally include one or more gyroscopes and/or one or more accelerometers.

Electronic device 201 includes hand tracking sensor(s) 202 and/or eye tracking sensor(s) 212 (and/or other body tracking sensor(s), such as leg, torso and/or head tracking sensor(s)), in some examples. Hand tracking sensor(s) 202 are configured to track the position/location of one or more portions of the user's hands, and/or motions of one or more portions of the user's hands with respect to the extended reality environment, relative to the display generation component(s) 214, and/or relative to another defined coordinate system. Eye tracking sensor(s) 212 are configured to track the position and movement of a user's gaze (eyes, face, or head, more generally) with respect to the real-world or extended reality environment and/or relative to the display generation component(s) 214. In some examples, hand tracking sensor(s) 202 and/or eye tracking sensor(s) 212 are implemented together with the display generation component(s) 214. In some examples, the hand tracking sensor(s) 202 and/or eye tracking sensor(s) 212 are implemented separate from the display generation component(s) 214.

In some examples, the hand tracking sensor(s) 202 (and/or other body tracking sensor(s), such as leg, torso and/or head tracking sensor(s)) can use image sensor(s) 206 (e.g., one or more IR cameras, 3D cameras, depth cameras, etc.) that capture three-dimensional information from the real-world including one or more body parts (e.g., hands, legs, or torso of a human user). In some examples, the hands can be resolved with sufficient resolution to distinguish fingers and their respective positions. In some examples, one or more image sensors 206 are positioned relative to the user to define a field of view of the image sensor(s) 206 and an interaction space in which finger/hand position, orientation and/or movement captured by the image sensors are used as inputs (e.g., to distinguish from a user's resting hand or other hands of other persons in the real-world environment). Tracking the fingers/hands for input (e.g., gestures, touch, tap, etc.) can be advantageous in that it does not require the user to touch, hold or wear any sort of beacon, sensor, or other marker.

In some examples, eye tracking sensor(s) 212 includes at least one eye tracking camera (e.g., IR cameras) and/or illumination sources (e.g., IR light sources, such as LEDs) that emit light towards a user's eyes. The eye tracking cameras may be pointed towards a user's eyes to receive reflected IR light from the light sources directly or indirectly from the eyes. In some examples, both eyes are tracked separately by respective eye tracking cameras and illumination sources, and a focus/gaze can be determined from tracking both eyes. In some examples, one eye (e.g., a dominant eye) is tracked by one or more respective eye tracking cameras/illumination sources.

Electronic device 201 is not limited to the components and configuration of FIG. 2A, but can include fewer, other, or additional components in multiple configurations. In some examples, electronic device 201 can be implemented between two computer systems (e.g., as a system). In some such examples, each of (or more) computer system may each include one or more of the same components discussed above, such as various sensors, one or more display generation components, one or more speakers, one or more processors, one or more memories, and/or communication circuitry. A person or persons using electronic device 201, is optionally referred to herein as a user or users of the system.

In one or more examples, and as described above, communication circuitry 222 of device 201 can be utilized to communicate with one or more external devices for the purpose of issuing commands to the device, and/or otherwise receiving and transmitting data/information from and to an external device. For instance, in one or more examples, and as described in detail below, device 201 can utilize communication circuitry 222 to communicate with an electronic pointing device. In some examples, an electronic pointing device is a device that can be used to interact with a three-dimensional environment as detailed below. In some examples, the electronic pointing device can include internal circuitry that enables the electronic pointing device to receive commands from electronic device and/or perform functionality associated with the electronic pointing device as illustrated in FIG. 2B.

FIG. 2B illustrates a block diagram of an example architecture for an electronic pointing device according to some examples. In some examples, electronic pointing device 224 includes communication circuitry 226 that is configured to allow the electronic pointing device 224 to remain communicatively coupled with an electronic device such as electronic device 201 described with respect to FIG. 2A. In some examples, communication circuitry 226 can include circuitry configured to facilitate wired and/or wireless communication with electronic device 201. For example, communication circuitry 226 can include one or more transmitters, receivers, transmitters, analog front-end modules, power amplifiers, low-noise amplifiers, antennas, universal serial buses, and/or some combination thereof that electronic device pointing device 224 to communicate with electronic device 201. In one or more examples, the communication circuitry 226 is communicatively coupled to processor 228 that is configured to receive communications from electronic device 201 and translate the communications to one or more commands that are used to operate the electronic pointing device 224 according to the commands provided by electronic device 201A.

In one or more examples, utilizing communication circuitry 226 in conjunction with processor 228, electronic pointing device 224 can receive and execute one or more commands from electronic device 201. For instance, electronic device 201 can provide a command to electronic pointing device 224 to generate a haptic feedback response using one or more haptic feedback engines 232a-232c. In some examples, haptic feedback engines 232a-232c are disposed at various locations within the electronic pointing device 224 and are configured to generate a haptic feedback response. In some examples, haptic feedback engines 232a-232c include one or more of a vibration component and/or an audio component that are configured to cause vibration and audio at the electronic pointing device 224 according to one or more patterns and with a desired magnitude.

Attention is now directed towards interactions with physical objects in the physical environment (e.g., presented in the three-dimensional environment). The interactions may also be applied to one or more virtual objects and/or visual representations of real-world objects that are displayed in a three-dimensional environment presented at a computer system (e.g., corresponding to electronic device 101). In some examples, the interactions may include detecting intersection and/or overlap between a virtual tool and a virtual object. In some examples, a pointing device can generate haptic feedback indicative of the intersection and/or overlap.

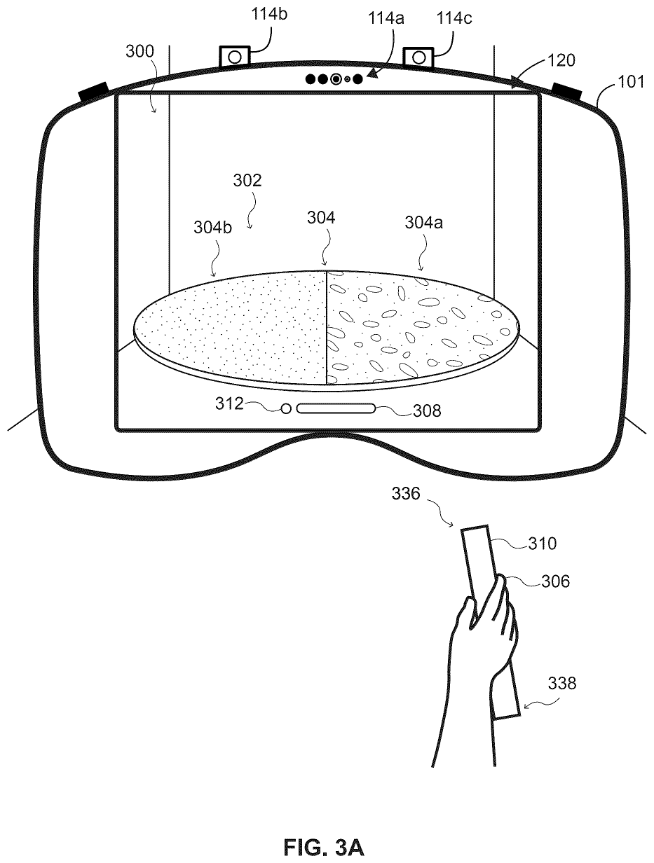

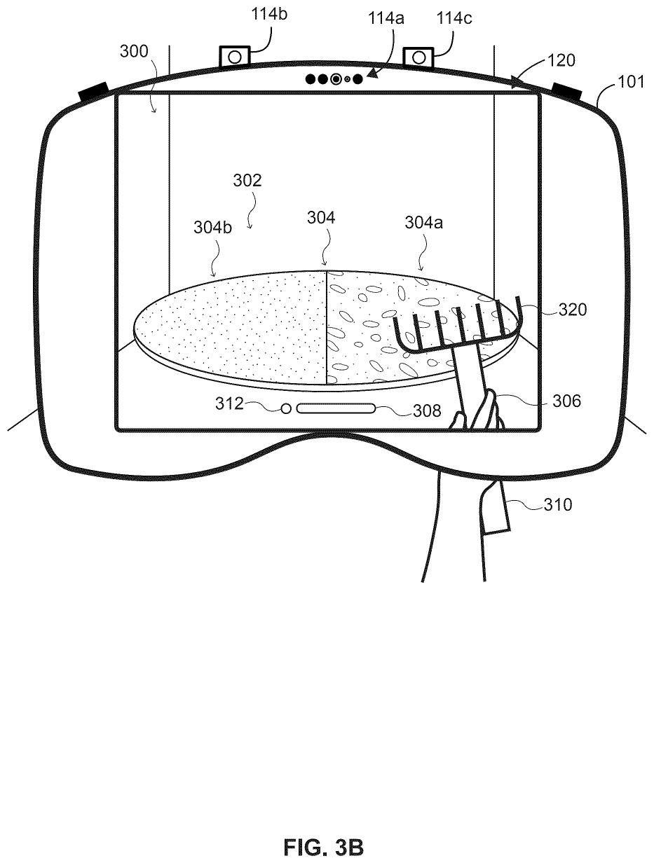

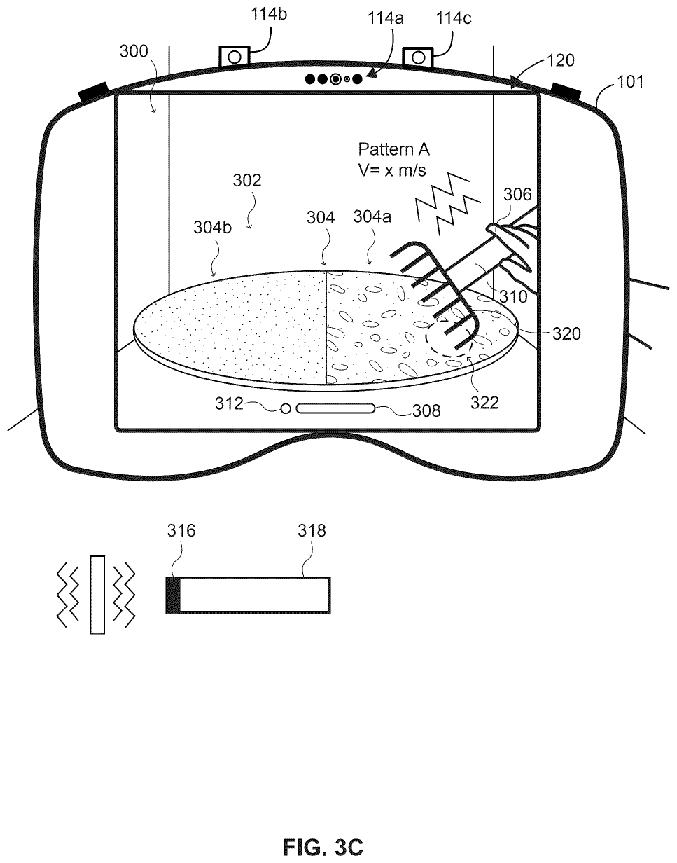

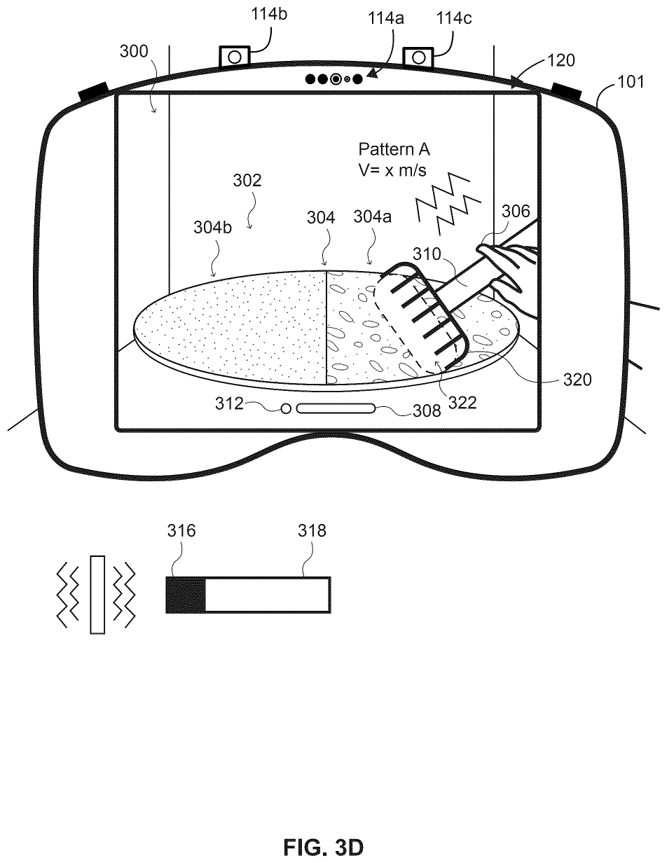

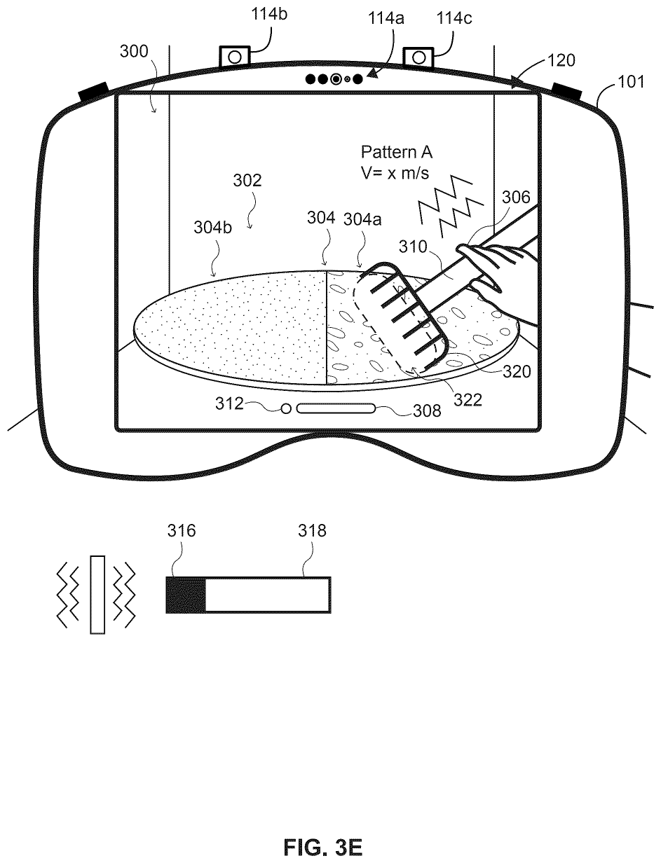

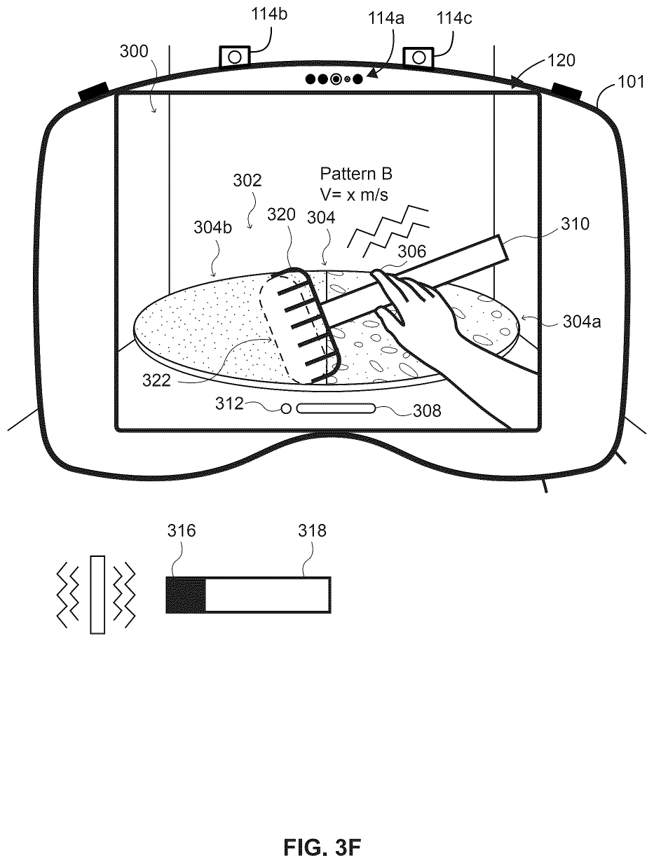

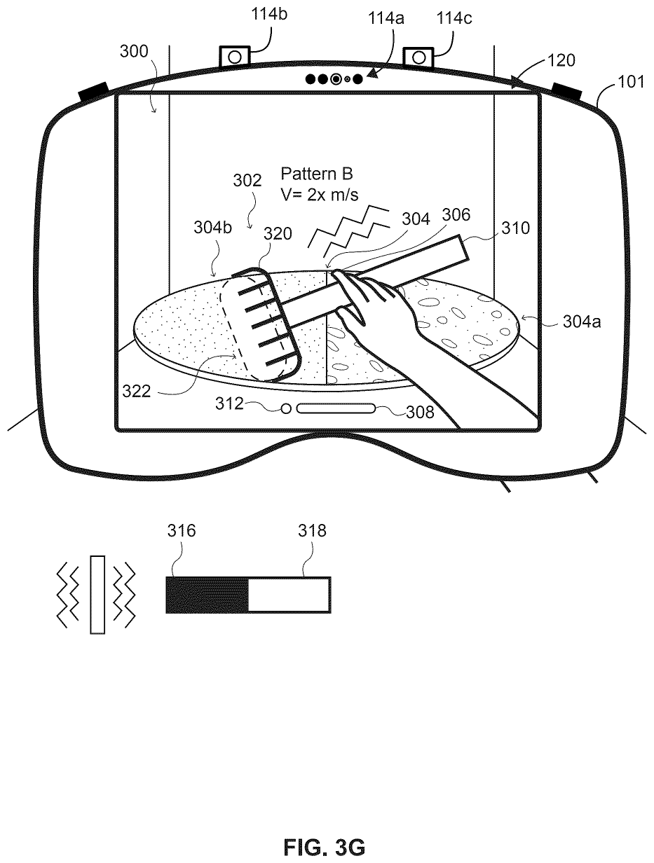

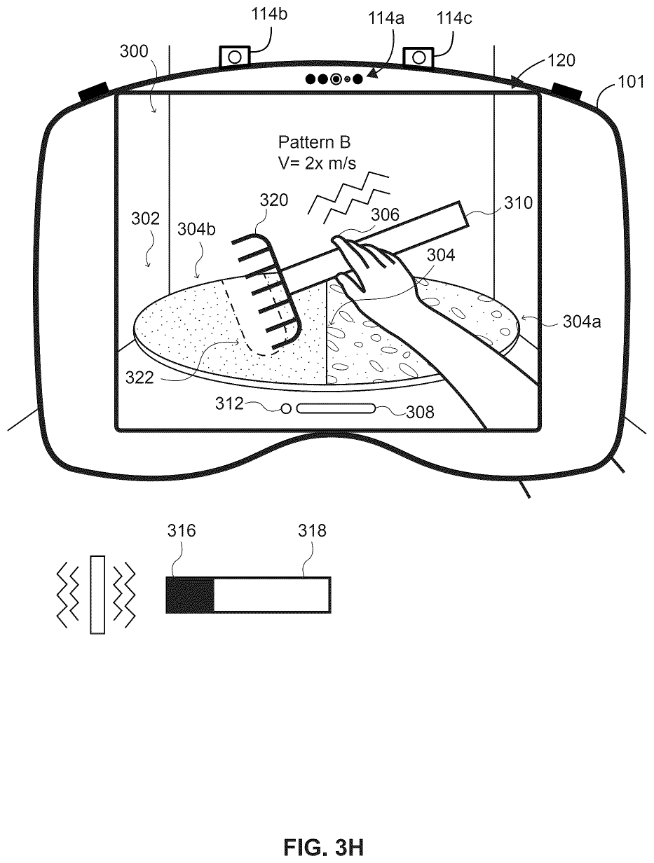

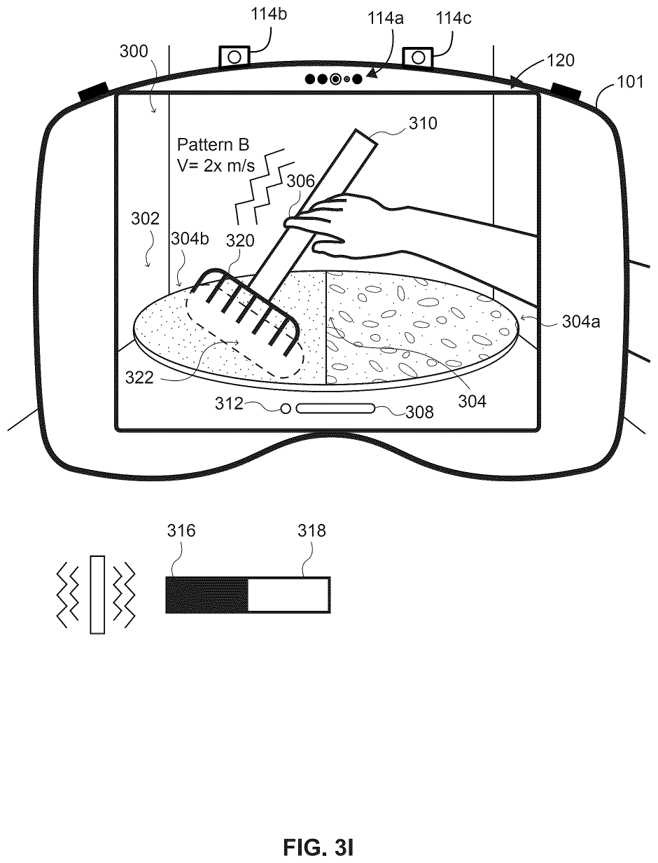

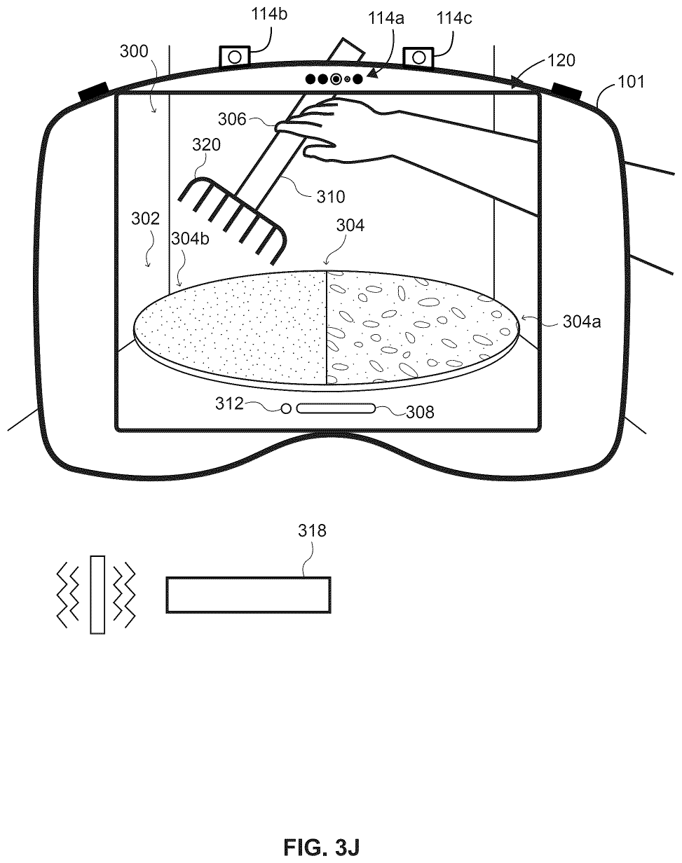

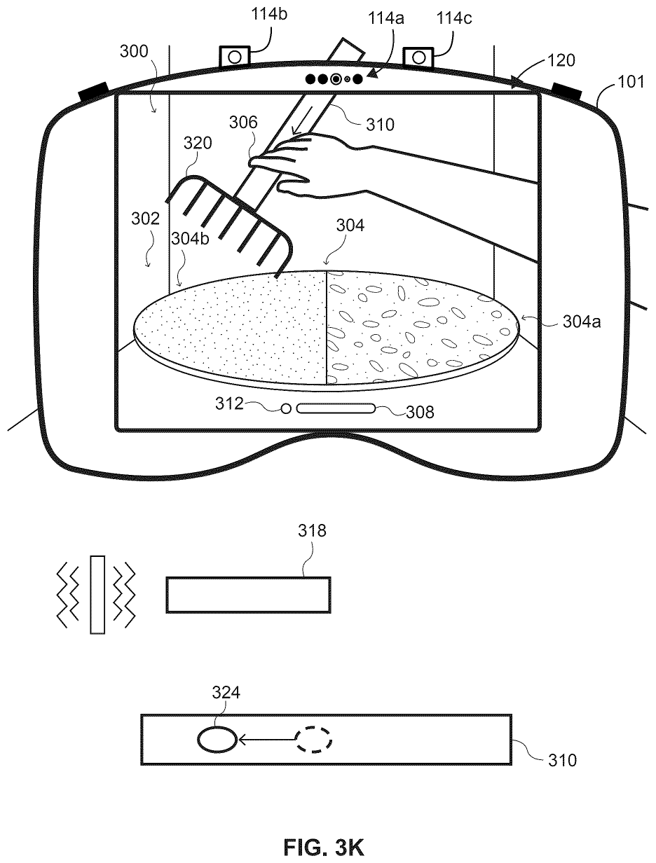

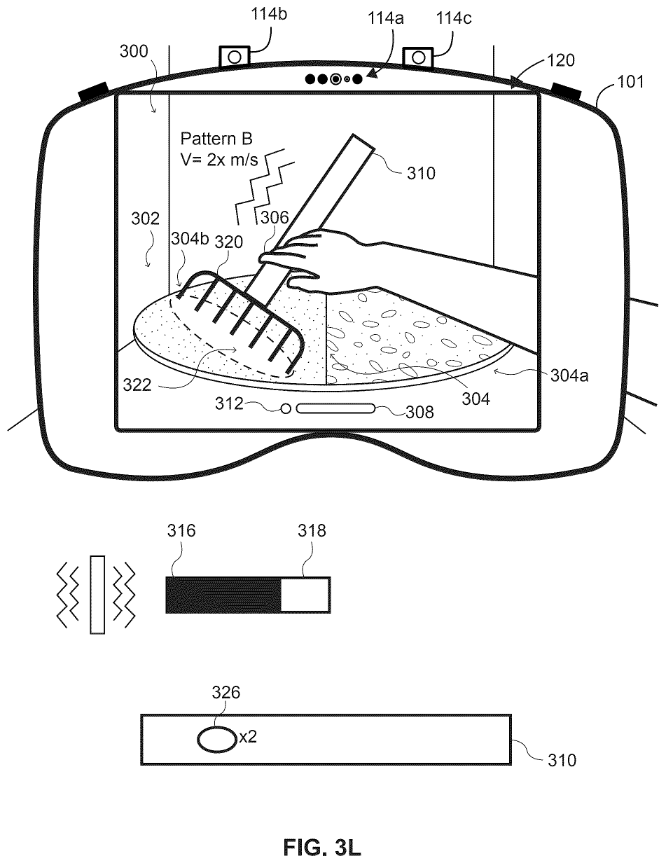

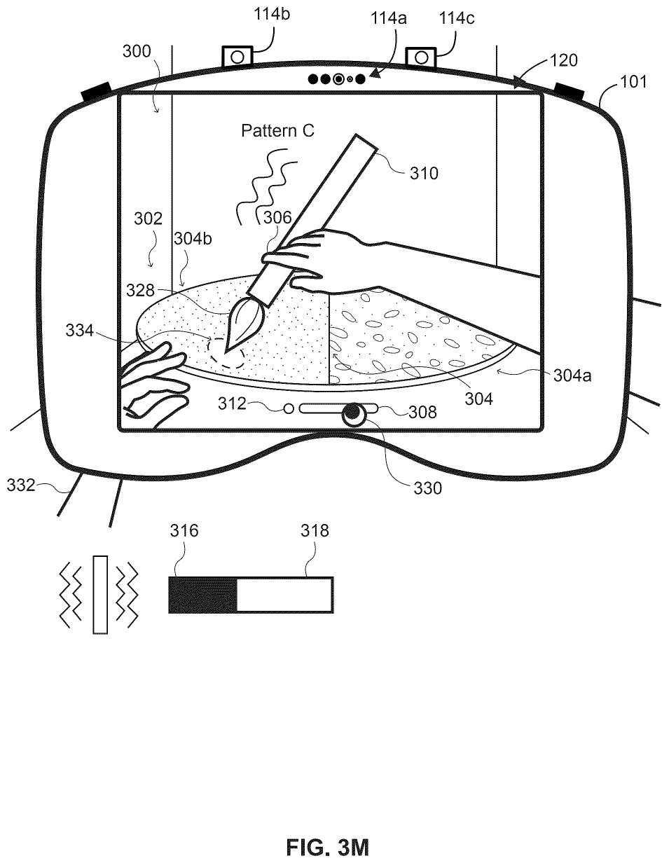

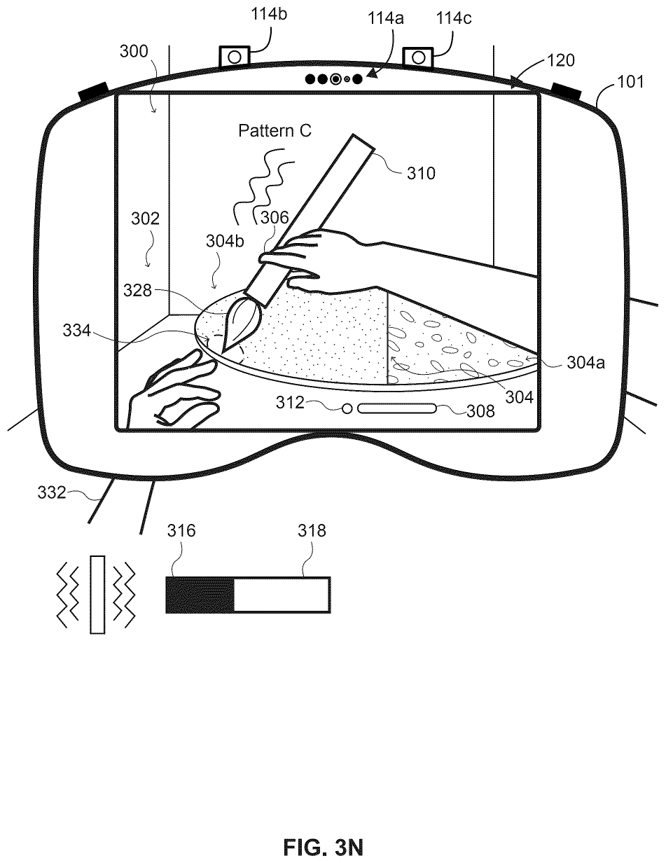

FIGS. 3A-3N illustrate methods of and systems for generating haptic feedback in accordance with interactions between virtual objects and a virtual tool in accordance with some examples of the disclosure. For example, FIGS. 3A-3N illustrate an example virtual sandbox including virtual sand, virtual rocks, and/or virtual water. Haptic feedback can be provided to a user via a pointing device 310 interacting with the virtual sand, virtual rocks, and/or virtual water in the sandbox, including different haptic responses for virtual tools, different virtual content, and/or different interactions therebetween. It is understood that the virtual objects and virtual tools illustrated in FIGS. 3A-3N are non-limiting examples.

FIG. 3A illustrates an electronic device 101 (e.g., tablet, smartphone, wearable computer, head mounted device, or other electronic device) presenting, via one or more displays (e.g., one or more displays 120 of FIG. 1A such as a computer display, touch screen, or one or more display modules of a head mounted device), a three-dimensional environment (e.g., an extended reality (XR) environment) from a viewpoint of the user of the electronic device 101 (e.g., facing a back wall of the physical environment in which electronic device 101 is located). In some examples, electronic device 101 includes one or more displays 120 and a plurality of image sensors 114a-114c (e.g., image sensors 114 of FIG. 1). The image sensors optionally include one or more of a visible light camera, an infrared camera, a depth sensor, or any other sensor the electronic device 101 would be able to use to capture one or more images of a user or a part of the user (e.g., one or more hands of the user) while the user interacts with the electronic device 101. In some examples, the user interfaces illustrated and described below could also be implemented on a head-mounted display that includes one or more displays that presents the user interface or three-dimensional environment to the user, and sensors to detect the physical environment and/or movements of the user's hands (e.g., external sensors facing outwards from the user), and/or attention (e.g., based on gaze) of the user (e.g., internal sensors facing inwards towards the face of the user).

As shown in FIG. 3A, electronic device 101 captures one or more images of the physical environment around electronic device 101, including one or more objects in the physical environment around electronic device 101. In some examples, electronic device 101 presents representations of the physical environment included in three-dimensional environment 300. For example, three-dimensional environment 300 includes representations of walls, a floor, and/or a ceiling (e.g., video, pictures, and/or a view of the physical environment visible through transparent materials) in the physical environment.

In FIG. 3A, three-dimensional environment 300 also includes one or more virtual objects. For example, as shown in FIG. 3A, the electronic device 101 is presenting a virtual object 302 in the three-dimensional environment 300. In some examples, virtual object 302 is a volumetric virtual object. For example, virtual object 302 virtually occupies a region comprising a plurality of locations included in three-dimensional environment 300. Virtual object 302 can have virtual dimensions, such as a virtual height, width, and/or length that defines the volume of virtual object 302. Some examples of a volumetric virtual object include a virtual container including a plurality of volumetric regions, virtual objects analogous to physical objects (e.g., cars, plates, chairs, and/or the like), virtual objects corresponding to fictitious objects (e.g., a unicorn, futuristic scientific tooling, and/or amorphous shapes such as a glowing cloud of colors), representations of users of other devices, and/or hybrid virtual objects that include one or more portions that respectively include one or more of the aforementioned types of virtual objects. As shown in FIG. 3A, virtual object 302 is a virtual object including two volumes 304a and 304b. As described further herein, volumes 304a and 304b can each correspond to volumetric regions that include virtual objects. Volume 304 can, for example, correspond to a virtual sandbox. The volume 304b can, for example, correspond to a first region that includes a first type of virtual content such as virtual sand. Volume 304a can, for example, correspond to a second region that includes a second type of virtual content such as virtual rocks and/or virtual water.

In some examples, the virtual object is or includes one or more of user interfaces of an application (e.g., an application running on the electronic device 101) containing content (e.g., windows presenting photographs, playback user interface presenting content, and/or web-browsing user interface presenting text), three-dimensional objects (e.g., virtual clocks, virtual balls, and/or virtual cars) or any other element presented by electronic device 101 (e.g., tablet, smartphone, wearable computer, or head mounted device) that is not included in the physical environment of one or more displays 120.

In some examples, virtual object 302 comprises one or more volumes 304, such as volume 304a and/or volume 304b. In some examples, volumes 304 are associated with one or more virtual textures, densities, and/or other simulated physical properties (e.g., as described with reference to method 400). In some examples, the simulated physical properties are selected and/or configured to simulate interactions between analogous physical volumes of an analogous physical object. For example, volume 304a can be a volume included in virtual object 302 that includes virtual sand and/or virtual rocks. Accordingly, volume 304a can be configured with a first density, first simulated frictional coefficients, first viscosities, and/or the like. As described with reference to method 400 and/or with reference to subsequent figures illustrated herein, when a simulated tool is moved to intersect, pierce, and/or travel through volume 304a, electronic device 101 can cause generation of haptic feedback (e.g., at pointing device 310) and/or can generate haptic feedback to simulate the sensation of a physical object moving through the physical volume that is analogous to the volume 304a based on the physical properties. In some examples, a volume can be non-uniform, such that a first portion of the volume corresponds to a first set of simulated physical properties and a second portion of the volume corresponds to a second set of simulated physical properties.

Generating haptic feedback using the simulated physical properties may improve the granularity by which an electronic device and/or pointing device is capable of generating haptic feedback with respect to virtual textures and surfaces, enhancing the realism of interactions between the pointing device and the virtual objects. Due to the enhanced haptic feedback, users of such devices may be less likely to move the pointing device erroneously, such as into physical objects, beyond regions of the virtual object within which haptic feedback are generated, and/or away from virtual content which may cause a simulated physical interaction, thereby reducing power consumption required to correct for erroneous inputs and reducing the processing required to detect and/or correct for the erroneous inputs.

In some examples, volume 304b has one or more characteristics that are similar to, or are the same as, described with reference to volume 304a. In some examples, volume 304b has one or more characteristics that are different from those described with reference to volume 304a. For example, volume 304a and 304b can both be included in a virtual object, and can respectively span a height, width, and/or length relative to three-dimensional environment 300. In some examples, volume 304a and 304b can differ with respect to their respective simulated densities, viscosities, spatial profiles (e.g., their shape and/or their precise dimensions), the number of different surfaces included in a volume, and/or parameters that otherwise dictate the characteristics of haptic feedback generated by a pointing device when a simulated tool intersects with the volume, as described further below. For example, volume 304b can correspond to a region including simulated sand, and volume 304a can correspond to a region that includes simulated liquid such as water. As described further herein such as with reference to method 400, electronic device 101 can generate haptic feedback when pointing device 310 moves through volume 304b that is different from haptic feedback generated when pointing device 310 moves through volume 304a.

In some examples, electronic device 101 is in communication with pointing device 310 (e.g., wirelessly and/or wired communications). In some examples, pointing device 310 is one of a plurality of input devices that electronic device 101 is in communication with. In some examples, pointing device 310 has one or more characteristics of the pointing device(s) described with reference to method 400. For example, pointing device 310 can be a peripheral device that a user of electronic device 101 is able to use to point toward, interact with, initiate presenting of, and/or cease presenting of virtual content. For example, pointing device 310 can be associated with one or more pointing tips, such as a first tip 336 corresponding to a first end of an oblong housing of pointing device 310 and a second tip 338 corresponding to a second end of the housing, opposite the first end. In some examples, electronic device 101 presents a cursor and/or another visual indication such as a simulated glowing effect at a location in three-dimensional environment corresponding to a projection from the first tip of the pointing device 310. Pointing device 310 can detect input such as selection of one or more buttons of the pointing device, movement of one or more sliders or joysticks of the pointing device, movement of one or more contacts on a trackpad of the pointing device, contacting or double-contacting on a surface of the trackpad, squeezing of (e.g., applied force on) the housing, and/or the like. In response, pointing device 310 can communicate indications of such input to electronic device 101. In response to detecting such indications, electronic device 101 can initiate operations, such as selecting of virtual buttons and/or content (e.g., presented via the one or more displays of electronic device 101), initiating playback of media (e.g., via speakers of electronic device 101), presenting simulated drawing and/or markings in accordance with the movement of the pointing device 310, and/or the like. Such a communication scheme may reduce the inputs that may be individually detected by electronic device 101 and/or pointing device 310, allowing for inputs at a first device to optionally initiate operations at a second device (and/or vice versa), thereby reducing processing required to detect and perform operations for respective inputs directed to respective devices.

In some examples, as described further herein, electronic device 101 presents a simulated tool corresponding to pointing device 310. In some examples, the simulated tool can interact with objects in three-dimensional environment 300 (e.g., the virtual representation of the stimulated tool rather than the tip 336 or 338 as the interaction point). Additionally, as described with reference to FIG. 3C, electronic device 101 can communicate requests to pointing device 310, which when received, can cause pointing device 310 to generate haptic feedback indicating interaction with the objects. The present disclosure contemplates various examples in which electronic device 101 and/or pointing device 310 can generate the haptic feedback, thus reducing the likelihood that a user of electronic device 101 is unaware of a spatial relationship between pointing device 310 and objects in three-dimensional environment 300, and/or enhancing the user's experiences by lending a tactile experience while interacting with virtual content.

Turning back toward virtual object 302, in some examples, one or more virtual objects are associated with one or more selectable options configured to control the corresponding virtual objects. For example, selectable option 312 can be selectable to cause presentation of additional or alternative controls associated with virtual object 302, and/or can be selectable to cause ceasing of presentation of virtual object 302. It is understood that examples in which virtual content is “selectable” correspond to examples in which electronic device 101 and/or pointing device 310 can detect an input directed toward the particular virtual content, and in response to detecting the input, can perform an operation related to the input. For example, electronic device 101 can detect attention of a user of electronic device 101 directed to selectable option 312 and can detect a concurrent air gesture, and in response, can cease presentation of virtual object 302.

In FIG. 3A, grabber 308 is a first virtual control associated with virtual object 302, and is presented with an oblong shape adjacent to virtual object 302. In some examples, in response to detecting input directed to grabber 308, electronic device 101 initiates a process to move virtual object 302 relative to three-dimensional environment 300. For example, electronic device 101 can detect attention (e.g., gaze) directed to grabber 308 concurrent with an air gesture performed by hand 306 (e.g., an air pinch including contacting of a plurality of fingers, an air pointing of one or more fingers, an air curling of one or more fingers, and/or an air splaying of one or fingers away from each other). In response to detecting the concurrent attention and air gesture, electronic device 101 can initiate movement of virtual object 302 in accordance with movement of the hand 306 and/or the fingers performing the air gesture. For example, while an air pinch is maintained, electronic device 101 can detect movement of the air pinch in one or more first directions by one or more first magnitudes (e.g., distances, speeds, and/or accelerations). In response to detecting the movement, electronic device 101 can move virtual object 302 in one or more second directions and/or by one or more second magnitudes based upon the one or more first directions and/or the one or more first distances. For example, in response to detecting leftward movement of the air pinch relative to the three-dimensional environment by a first distance, electronic device 101 can move virtual object 302 leftward (or rightward) by a second distance that is based upon the first distance (e.g., is the same, is mathematically derived from, and/or is algorithmically derived from the first distance to be greater than or less than the first distance), as described with reference to FIG. 3M and FIG. 3N.

It is understood that some examples described herein with reference to moving of the virtual object can additionally or alternatively apply to moving of a virtual tool that corresponds to pointing device 310 (e.g., the virtual tool described further below). For example, electronic device 101 can detect movement of an air gesture, and in response, can move the virtual tool in accordance with the air gesture movement. Thus, the virtual tool can at least temporarily be moved away from pointing device 310 in accordance with an air gesture. In some examples, when the virtual tool is moved away from pointing device 310, electronic device 101 detects movement of pointing device 310 within a threshold distance of where the virtual tool is presented. In response to detecting such movement, electronic device 101 can present the virtual tool corresponding to the location of pointing device 310, such as rotating and/or aligning the virtual tool with the dimensions of pointing device 310.

In some examples, electronic device 101 moves virtual object 302 in accordance with additional or alternative input than the attention and/or air gesture described above. For example, electronic device 101 can detect voice input requesting movement of virtual object 302 to predetermined positions relative to a viewpoint of a user of electronic device 101 (e.g., relative to the user's location and/or orientation relative to three-dimensional environment 300), and/or to predetermined positions in three-dimensional environment 300. In response to detecting the voice input, electronic device 101 can move virtual object 302 to the predetermined position(s). Additionally or alternatively, the voice input is intelligently parsed by electronic device 101 and/or in conjunction with peripheral computing device such as servers to understand the user's intent implicit in their voice request, such as a request to move the virtual object 302 generally away from the viewpoint of the user and/or a request to move the virtual object to 302 to sit atop and/or be world-locked to physical or virtual content in three-dimensional environment 300. In response to determining and/or receiving an indication of the user's intent, electronic device 101 can move virtual object 302 to the requested location. Thus, electronic device 101 can use results from one or more natural language models (e.g., and/or additional or alternative procedures in which artificial intelligence models parse the user's voice input) to determine a destination of movement of virtual object 302.

In some examples, electronic device 101 can move virtual object 302 in accordance with input directed to pointing device 310. For example, pointing device 310 can detect input such as a contacting of one or more fingers with a housing of pointing device 310 and/or a touch-sensitive surface such as a trackpad, a selection of a virtual button, a squeezing with a force that exceeds a threshold amount of force, a sequence of one or more contacts with the housing of pointing device 310, and/or some combination thereof. In some examples, pointing device includes force sensors, touch sensors, proximity sensors, and/or some combination of one or more of such sensors to detect the movement and/or contact of the user's body with the housing of pointing device 310. In some examples, pointing device 310 communicates an indication of such input(s) to electronic device 101. In response to detecting the indication of the input(s), electronic device 101 can initiate movement of virtual object 302. For example, in response to detecting an indication of a pressing of a button, electronic device 101 can enable a movement mode of virtual object 302. While the movement mode is enabled, electronic device 101 can move virtual object 302 in accordance with movement of pointing device 310 (e.g., even when the button is not concurrently pressed) in a manner similar to or the same as described with reference to movement of virtual object 302 based on movement of an air gesture. Additionally or alternatively, electronic device 101 can move the virtual object 302 while the button is pressed and can forgo and/or cease movement of virtual object 302 in response to detecting ceasing of the pressing of the button.

In some examples, in response to detecting contact with the button and/or a portion of the housing of electronic device 101 or pointing device 310, electronic device 101 initiates movement of the virtual object 302. In some examples, electronic device 101 moves the virtual object 302 in accordance with movement of pointing device 310 after the contact is detected and/or while the contact is maintained. In some examples, pointing device 310 detects that a force of the contact increases to be greater than a threshold amount of force, and in response, electronic device 101 performs one or more operations associated with virtual object 302. For example, while the contact is maintained, pointing device 310 detects contact force increase beyond a threshold (e.g., 0.5, 1, 1.5, 2, 3, or 5 N), and in response, transmits an indication to electronic device 101 to initiate an operation. The operation can include one or more of displaying a menu including one or more selectable options to modify the position, orientation, visual appearance, and/or display information related to virtual object 302. The operation can additionally or alternatively include initiating of an editing operation related to the virtual object 302. For example, electronic device 101 can temporarily lock the position of virtual object 302, and can change the dimensions of, add simulated markings to (e.g., by moving the pointing tips of pointing device 310 and/or the virtual tool over surfaces of virtual object 302), and/or change an orientation of virtual object 302 in accordance with movement of pointing device 310.

Some examples of the disclosure include performing operations at electronic device 101 and/or pointing device 310 in response to detecting input(s) and/or criteria that are satisfied. For example, some examples described herein include electronic device 101 detecting that pointing device 310 has received an input, and in response to detecting an indication of the detected input from pointing device 310, electronic device 101 can perform one or operations such as moving of a virtual object and/or generating (or causing pointing device 310 to generate) haptic feedback. In such examples, pointing device 310 can communicate an indication of the input or inputs to electronic device 101, which when detected by electronic device 101, can cause electronic device 101 to perform the operations and/or communicate a request for pointing device 310 to perform the operations (e.g., to generate haptic feedback). In response to detecting and/or receiving the request, pointing device 310 can perform the requested operation(s) and/or additional or alternative operations related to the request. It is understood that additionally or alternatively, electronic device 101 can detect the input directed toward pointing device 310 and can communicate the request to pointing device 310. For example, pointing device 310 can be in a passive or power saving mode, and electronic device 101 can use cameras, ultrasonic, electromagnetic, capacitive, and/or additional or alternative sensing modalities to detect movement of pointing device 310 and/or contact directed to the housing and/or buttons included in pointing device 310. In response to detecting the inputs directed toward pointing device 310, and without detecting an indication of the inputs by pointing device 310, electronic device 101 can communicate the request to the pointing device, which when received, can cause pointing device 310 to generate haptic feedback and/or perform additional or alternative operations.

Similarly, when electronic device 101 detects input, it is understood that in additional or alternative examples, pointing device 310 can detect the input in lieu of electronic device 101. In such examples, pointing device 310 can communicate an indication of the input to electronic device 101, which when detected at electronic device 101, can cause electronic device 101 to perform operations similar to or the same as those described from the perspective of electronic device 101 performing both input detection and operational execution.

From FIG. 3A to FIG. 3B, pointing device 310 is moved to a location that is within a viewport of electronic device 101 presented to the user of the electronic device. As described further herein, the viewport of electronic device 101 can include the regions of three-dimensional environment 300 that are detected by and/or represented via one or more displays 120. In some examples, pointing device 310 is associated with a simulated tool as described with reference to method 400. In some examples, simulated tool 320 is presented via the one or more displays. In some examples, the simulated tool 320 is a tool that is fictitious and/or has a physical equivalent. Simulated tool 320 in FIG. 3B, for example, corresponds to a virtual rake including a plurality of spokes or teeth. In some examples, the body of a tool can correspond to the housing of pointing device 310. For example, electronic device 101 presents a barrel of a pen and/or a handle of a rake overlaying the housing of pointing device 310. Electronic device 101 can display an operative portion of the virtual tool such as the teeth of the rake and/or a pen nib of the pen extending from the housing of pointing device 310, as described further below.

In some examples, simulated tool 320 is presented at a location and/or with an orientation that corresponds to a position of the pointing device 310 relative to three-dimensional environment 300. For example, in FIG. 3B, simulated tool 320 is pointing toward a ceiling in three-dimensional environment 300 because a first tip 336 of pointing device 310 is pointed in that direction. Accordingly, electronic device 101 presents simulated tool 320 that has an axis that extends parallel to and overlaps with the axis that extends parallel to the oblong dimension of pointing device 310 through the first tip. As described further with reference to method 400, the simulated tool 320 can correspond to additional or alternative objects and/or tools, such as a mallet, a drumstick, a butter knife, and/or the like.

In FIG. 3B, pointing device 310 and simulated tool 320 are not intersecting or otherwise interacting with virtual object 302. From FIG. 3B to FIG. 3C, electronic device 101 detects movement and/or an indication of movement of pointing device 310 to a location and/or to assume an orientation that causes virtual intersection between simulated tool 320 and virtual object 302. For example, simulated tool 320 in FIG. 3C is pointed downward, such that one or more teeth of the rake virtually intersect with volume 304a. A virtual intersection—as described further herein—can include examples in which locations that a simulated tool occupies, overlaps with, is bounded by, and/or passes through locations in three-dimensional environment 300 that define a virtual surface and/or region of virtual content. For example, as shown in FIG. 3C, the virtual rake teeth extend into the volume 304a. Accordingly, electronic device 101 can determine that the simulated tool 320 is intersecting volume 304a. In some examples, electronic device 101 generates and/or causes pointing device 310 to indicate that a virtual intersection is initiated. For example, electronic device 101 can display a visual effect, such as a simulated glow, at the location of intersection between simulated tool 320 and/or volume 304a in FIG. 3C. Additionally or alternatively, electronic device 101 can change display of portions of volume 304a and/or regions of three-dimensional environment 300 within a threshold distance (e.g., 0.01, 0.1, 0.25, 0.5, 0.75, 1, 2.5, 5, 10, 20, or 50 cm) around the region 322 of intersection. For example, electronic device 101 can change the opacity, brightness, saturation, and/or can apply a visual blurring effect in and/or around the region 322 of intersection to be less opaque, more or less bright, less saturated, and/or more blurred that prior to the intersection. In presenting such interactive virtual objects, a user of the electronic device may not require the presence of physical objects and/or require the same physical actions to interact with the physical object that correspond to the virtual equivalents of interactions with the virtual content. Additionally, electronic device 101 and/or pointing device 310 may generate feedback with respect to virtual objects such as the haptic feedback and/or the changing of the visual characteristics may allow electronic device 101 and/or pointing device 310 to generate feedback that may guide a user to forgo entry of erroneous inputs and/or may assist the user in interacting with virtual content in a way that is intended by a developer of an application corresponding to the virtual object.

In some examples, electronic device 101 and/or pointing device 310 can generate haptic feedback to indicate that a virtual intersection is initiated and/or exists. For example, as described with reference to method 400, pointing device 310 can generate or fire haptics using haptic circuitry included in pointing device 310 (e.g., one or more haptic processors or engines, one or more piezoelectric actuators or other wave generators, one or more motors, and/or the like). In some examples, haptic feedback is generated in response to detecting movement of pointing device 310 while simulated tool 320 intersects with virtual object 302 and/or the volumes included in virtual object 302. In some examples, haptic feedback generated when a virtual intersection is initiated is different from haptic feedback generated when the virtual intersection is ongoing. For example, pointing device 310 can detect and/or receive an indication of the beginning of intersection between simulated tool 320 and volume 304a, and can generate haptic feedback of one or more amplitudes. After generating the initial haptic feedback, pointing device 310 can continue to generate haptic feedback while simulated tool 320 continues to intersect volume 304a (and/or, in response to detecting movement of pointing device 310 while the virtual elements intersect), including one or more amplitudes that are different from the initial haptic feedback.

As described further with reference to method 400, it is understood that haptic feedback being “different” can include varying one or more characteristics of the haptic feedback to provide a different physical sensation to a user holding and/or in contact with the pointing device 310. For example, the frequency content of the haptic feedback, the number of haptic elements located within pointing device 310 that are firing, the arrangement of the haptic elements that are firing, the magnitude of the haptic response generated by the haptic elements, the temporal and/or spatial pattern of the firing of the haptics, the duration of bursts of haptic feedback, the selected types of haptic elements that are fired (e.g., motors only, piezoelectric actuators only, and/or a combination of both types), and/or some combination thereof can be different when presenting different haptic feedback patterns and/or when presenting different haptic feedback responses. Thus, the particular manner by which electronic device 101 conveys haptic feedback can vary to differentiate between different virtual intersections, such as the initiation of a virtual intersection compared to a continuing of a virtual intersection, and/or such as the movement from a first volume and/or a first virtual object to a second volume and/or a second virtual object.

In FIG. 3C, pointing device 310 generates first haptic feedback (e.g., “Pattern A) with a first magnitude 316 shown in glyph 318. It is understood that, in some examples, reference to a “pattern” of haptic feedback can include a variety of above-described characteristics to simulate a sensation of a tool interacting with an object, such as the virtual rake depicted herein moving through virtual sand or the virtual rake moving through virtual liquid.

In some examples, electronic device 101 varies haptic feedback in accordance with the simulated extent to which a simulated tool and/or a virtual object moves. For example, in FIG. 3C, electronic device 101 detects virtual object 302 is static and simulated tool 320 is moving with a first speed (e.g., “x m/s”). Electronic device 101 in FIG. 3C can determine the simulated physical properties of volume 304a, can determine physical properties of simulated tool 320 (e.g., a density, a material, a spatial profile, a frictional coefficient, and/or the like), and/or can determine the speed of pointing device 310. Based on the combination of such features, electronic device 101 can cause pointing device 310 to generate the haptic feedback pattern and/or haptic feedback magnitude 316. As described further herein, moving the virtual object at a relatively faster rate can relatively increase (or decrease) the magnitude of the haptic feedback, can change the particular combination of frequencies and/or waves included in the haptic feedback, and/or can otherwise increase (or decrease) the magnitude of the haptic feedback.

In some examples, pointing device 310 changes the magnitude of generated haptic feedback in response to detecting inputs increasing the degree of intersection between simulated tool 320 and virtual object 302. For example, from FIG. 3C to FIG. 3D, pointing device 310—and accordingly, simulated tool 320—moves such that simulated tool 320 is pushed deeper into volume 304a. As shown from FIG. 3C to FIG. 3D, the region 322 of intersection grows as a greater number of teeth of simulated tool 320 intersect with the volume 304a, and/or in accordance with a determination that intersecting portions of a bounding box and/or a plurality of bounding volumes surrounding the dimensions of simulated tool 320 are greater than in a previous state of intersection. Accordingly, from FIG. 3C to FIG. 3D, the degree of intersection—which can include the locations corresponding to the teeth of the rake and/or surrounding the teeth of the rake that overlap with and/or are bound by a surface of volume 304a—increases, as visually indicated by the increasing in size of region 322.

In response to detecting the movement and/or an indication of the movement, electronic device 101 can cause pointing device 310 to increase the magnitude 316 of generated haptic feedback. In FIG. 3D, the haptic pattern is the same as shown in FIG. 3C (e.g., “Pattern A”), but the magnitude 316 is relatively increased. For example, the number of haptic waves generated over a period of time can be the same, but the amplitude of those waves can be greater as shown in FIG. 3D than as shown in FIG. 3C. Additionally or alternatively, the temporal pattern of recurrent and/or pseudo-random vibrations simulating the sensation of a rake pushing into sand can be similar as shown in FIG. 3C to as shown in FIG. 3D, but the strength of a vibration generated or simulated by pointing device 310 can increase from FIG. 3C to FIG. 3D. It is understood that in general, when moving pointing device 310 relative to a volume of first simulated physical properties, pointing device 310 can generate haptic feedback maintaining one or more first characteristics to maintain a general sensation of haptic feedback, such as maintaining of frequencies of generated haptic waves, from FIG. 3C to FIG. 3D.

In some examples, electronic device 101 and/or pointing device 310 maintains the pattern and/or magnitude of haptic feedback generated in response to detecting that simulated tool 320 moves through virtual object 302 and does not change the degree of intersection between simulated tool 320 and virtual object 302. For example, from FIG. 3D to FIG. 3E, electronic device 101 and/or pointing device 310 detect movement of pointing device 310 such that simulated tool 320 maintains a constant depth and/or degree of intersection with volume 304a. Because the degree of intersection indicated by region 322 and/or the speed of the simulated tool 320 is maintained from FIG. 3D to FIG. 3E (e.g., the depth of the simulated tool 320 relative to volume 304a and/or the velocity of simulated tool 320), pointing device 310 continues to generate haptic feedback including a same pattern (e.g., “Pattern A”) including the same magnitude 316 as previously shown in FIG. 3D. In some examples, in response to detecting ceasing of movement of pointing device 310, and while simulated tool 320 intersects with volume 304a, electronic device 101 causes pointing device 310 to cease generation of the haptic feedback, and/or changes the haptic feedback to be weaker (e.g., lower amplitude, higher frequency, to be generated with a different periodicity, and/or some combination thereof). In some examples, in response to detecting a ceasing of movement of pointing device 310 and/or simulated tool 320 relative to volume 304a and while the virtual elements continue to intersect, electronic device 101 and/or pointing device 310 cease generation of the haptic feedback. In these and other ways described herein, pointing device 310 may generate haptic feedback which may indicate a degree of intersection and/or may indicate the direction, speed, and/or amount of intersection between the pointing device 310, thereby guiding three-dimensional interactions between the pointing device 310 and virtual content and reducing the likelihood the user may erroneously move pointing device 310 in the three-dimensional environment.

In some examples, electronic device 101 and/or pointing device 310 change the haptic feedback from a first haptic feedback to second haptic feedback in response to detecting simulated tool 320 change from intersecting with a first surface and/or volume to intersecting with a second surface and/or volume, different than the first surface and/or volume. For example, from FIG. 3E to FIG. 3F, electronic device 101 and/or pointing device 310 detect movement of pointing device 310 relative to three-dimensional environment 300. In FIG. 3F, the virtual intersection between simulated tool 320 and virtual object 302 changes relative to the example of FIG. 3E. For example, simulated tool 320 in FIG. 3F intersects with volume 304b, instead of volume 304a. In some examples, when the surface and/or region that simulated tool 320 intersects with changes, electronic device 101 and/or pointing device 310 change the haptic feedback generated by pointing device 310. For example, from FIG. 3E to FIG. 3F, pointing device changes from generating a first haptic feedback pattern (e.g., “pattern A”) to generating a second haptic feedback pattern (e.g., “pattern B”) because the virtual content in volume 304b is different from virtual content in volume 304a. As an example, volume 304b can include virtual sand while volume 304a can include a combination of virtual rocks and sand, volume 304a can include virtual water while volume 304b can include virtual molasses, and/or the like. In some examples, the magnitude of the first and the second haptic feedback pattern are the same. For example, magnitude 316 as shown in FIG. 3E is the same as shown in FIG. 3F. As one example, one or more characteristics of the first haptic feedback can be the same as one or more characteristics of the second haptic feedback (e.g., an amplitude of one or more waves, a frequency range and/or a number of generated haptic feedback waves, a spatial distribution of haptic feedback relative to a housing of pointing device 310, and/or the like). In some examples, one or more characteristics of the first haptic feedback can be different from one or more characteristics of the second feedback (e.g., one or more of the above-described characteristics, and/or one or more patterns of change in amplitude such as a ramping of amplitude over time and/or a decreasing in amplitude over time).

In some examples, the haptic feedback changes due to the change in which the surface and/or region simulated tool 320 intersects with, while other factors that typically affect the haptic feedback are maintained. For example, in both FIG. 3E and FIG. 3F, the degree of intersection between simulated tool 320 and virtual object 302 can be the same. For example, a size and/or volume of region 322 in FIG. 3E is a same size and/or volume as region 322 in FIG. 3F. Additionally, the simulated velocity of simulated tool 320 as shown in FIG. 3E and FIG. 3F are the same (e.g., “x m/s”). Additionally or alternatively, the depth of simulated tool 320 relative to volume 304a in FIG. 3E can be the same as the depth of simulated tool 320 relative to volume 304b.

As described above, in some examples, electronic device 101 changes haptic feedback in accordance with a simulated velocity and/or acceleration of simulated tool 320 and/or virtual object 302 relative to one another. For example, from FIG. 3F to FIG. 3G, electronic device 101 detects pointing device 310 increase in velocity (e.g., from “x m/s” to “2x m/s”). From FIG. 3F to FIG. 3G, electronic device 101 and/or pointing device 310 can detect hand 306 increase the speed of pointing device 310, continuing movement of pointing device 310 in a direction similar to or the same as in the above-described figures.

In some examples, the haptic feedback changes due to the change in velocity of simulated tool 320 while other factors that typically affect the haptic feedback are maintained. For example, in both FIG. 3F and FIG. 3G, the degree of intersection between simulated tool 320 and virtual object 302 can be the same. For example, a size and/or volume of region 322 in FIG. 3F is a same size and/or volume as region 322 in FIG. 3G. Additionally or alternatively, the depth of simulated tool 320 relative to volume 304b in FIG. 3F can be the same as the depth of simulated tool 320 relative to volume 304b in FIG. 3G. Additionally or alternatively, the orientation of simulated tool 320 and/or the specific region (e.g., volume 304b) simulated tool 320 intersects with can be the same. Thus, from FIG. 3F to FIG. 3G, the differentiating factor that is used by pointing device 310 to cause a difference in haptic feedback from FIG. 3F to FIG. 3G can correspond to a simulated velocity of simulated tool 320.

In some examples, electronic device 101 and/or pointing device 310 change the haptic feedback based upon a combination of velocity and degree of intersection. For example, from FIG. 3G to FIG. 3H, electronic device 101 and/or pointing device 310 detects movement of pointing device 310 causing simulated tool 320 to move away from the volume 304b, thus decreasing the depth of intersection between simulated tool 320 and volume 304b. For example, electronic device 101 decreases the size of region 322 from FIG. 3G to FIG. 3H in response to detecting the movement of pointing device 310. Consequentially, from FIG. 3G to FIG. 3H, pointing device 310 generates haptic feedback with magnitude 316 that is less than as shown in FIG. 3G.

In FIG. 3H, because simulated tool 320 continues to move through volume 304b, pointing device 310 continues to generate the same haptic feedback pattern (e.g., “pattern B”) as shown in FIG. 3G. In FIG. 3H, pointing device 310 moves at a depth that is different from that shown in FIG. 3G, but at a simulated speed of pointing device 310 that is the same speed as described with reference to FIG. 3G. Taken together, the net effect of the decrease in depth (e.g., even while moving at a same speed through volume 304b) serves to decrease the degree of intersection between simulated tool 320 and volume 304b. Accordingly, from FIG. 3G to FIG. 3H, electronic device 101 and/or pointing device 310 decrease the magnitude 316 of haptic feedback.

In some examples, electronic device 101 and/or pointing device 310 generate haptic feedback based upon some combination of the factors described herein, in a manner similar to or the same as described above. In some examples, the combination includes one or more algorithms and/or procedures assigning relative weights to the degree of intersection, the simulated physical properties, the velocity, the acceleration, and/or some combination of the aforementioned, and/or additional or alternative factors in determining the magnitude 316 of haptic feedback. For example, electronic device 101 can relatively weight the degree of intersection to have a value and/or impact on haptic feedback magnitude that is greater than a weight of the simulated velocity of simulated tool 320. Thus, different volumes of virtual content may have different characteristics which may guide the user to interact and/or not interact with the virtual content in manners that may be specific to the corresponding volumes, thereby improving the likelihood that the user may provide inputs that comport with the intent of applications that generate the virtual content.

In some examples, the haptic feedback generated by pointing device 310 varies based upon the orientation of pointing device 310 relative to an intersecting surface and/or volume. For example, from FIG. 3H to FIG. 3I (and/or from FIG. 3G to FIG. 3I), pointing device 310 moves such that an angle formed between a plane corresponding to the top-surface of volume 304b and an axis parallel to, and centered with the oblong dimension of the pointing device 310 changes. In response to detecting the movement, because the angle increases (e.g., approaching a normal from the plane), electronic device 101 and/or pointing device 310 changes the haptic feedback in accordance with the movement. In some examples, the change in haptic feedback is based upon the orientation of pointing device 310 and/or simulated tool 320 changing relative to volume 304b. In some examples, a volume of intersection between simulated tool 320 and volume 304b is maintained when the orientation of simulated tool 320 changes, and electronic device 101 causes pointing device 310 to generate haptic feedback. Thus, when the degree of intersection between the simulated tool 320 and volume 304b is maintained but the orientation between simulated tool 320 and volume 304b changes, pointing device 310 can change and/or generate ongoing haptic feedback in accordance with the change in orientation. For example, in response to detecting rotation of pointing device 310 toward the normal, electronic device 101 and/or pointing device 310 increase (or decrease) the magnitude 316 of the haptic feedback. In response to detecting movement of pointing device 310 away from the normal, electronic device 101 and/or pointing device 310 decrease (or increase) the magnitude 316 of the haptic feedback. It can be appreciated that in additional or alternative examples, electronic device 101 can change the haptic feedback in other manners (e.g., the haptic feedback pattern, and/or additional or alternative parts of the haptic feedback described herein), and/or that electronic device 101 can change the frequency content of the haptic feedback while maintaining a temporal pattern of the haptic feedback.

From FIG. 3I to FIG. 3J, pointing device 310 is removed from virtually intersecting with volume 304b. Accordingly, in FIG. 3J, pointing device 310 ceases generating haptic feedback. In some examples, while the pointing device 310 is not virtually intersecting with volume 304b, pointing device 310 is moved to reinitiate intersection with volume 304b. In response to detecting the subsequent intersection, pointing device 310 can generate haptic feedback, in a manner similar to or the same as described above.

In some examples, the relative size and/or scale of a simulated tool affects the haptic feedback generated in response to and/or while detecting a virtual intersection between the simulated tool and the corresponding virtual object. In some examples, in response to detecting input(s) changing a scale of the simulated tool, electronic device 101 and/or pointing device 310 changes the scale of the simulated tool. For example, from FIG. 3J to FIG. 3K, electronic device 101 and/or pointing device 310 detect input 324, which can correspond to an object such as a finger contacting a housing of pointing device 310 and/or moving along a dimension of the housing and/or shifting of the user's grip along pointing device 310. In some examples, in response to detecting movement of the contact in the first direction, electronic device 101 and/or pointing device 310 scale the simulated tool 320 in a first direction (e.g., increasing the scale of simulated tool 320). In some examples, in response to detecting the movement of the contact in a second direction, different from the first direction, electronic device 101 and/or pointing device 310 scale the simulated tool in a second direction (e.g., decreasing the scale of simulated tool 320). As shown in FIG. 3K, for example, pointing device 310 detects movement in a leftward direction, and accordingly scales the virtual rake corresponding to simulated tool 320 by an amount based upon the distance of the movement. For example, in response to detecting that the contact moves by a first distance, the electronic device 101 can scale the simulated tool 320 by a first amount (e.g., based on the first distance). In response to detecting that the contact moves by a second distance, the electronic device can scale the simulated tool 320 by a second amount (e.g., based on the second distance), different from the first distance (e.g., greater than or less than the first distance).

From FIG. 3K to FIG. 3L, pointing device 310 moves relative to virtual object 302. For example, in FIG. 3L, pointing device 310 moves such that simulated tool 320—now presented with the relatively greater scale than in FIG. 3J—intersects with volume 304b. In FIG. 3L, pointing device 310 generates haptic feedback with a magnitude 316 indicative of the scale of the simulated tool 320. For example, in FIG. 3L, the simulated tool 320 moves with a speed that is the same as the speed as shown in FIG. 3I. Because simulated tool 320 corresponds to a same virtual tool as described above, and volume 304b includes the same simulated physical properties as described above, and/or the pattern of the haptic feedback is the same as described above (e.g., “Pattern B”). As described above, the magnitude 316 of the haptic feedback can change, however, to indicate the region 322 of intersection between simulated tool 320 and volume 304b. For example, the region 322 is bigger in FIG. 3L than as shown in FIG. 3I because the simulated tool 320 is bigger in FIG. 3L; consequentially, the magnitude 316 of haptic feedback in FIG. 3L is greater than shown in FIG. 3I.

In FIG. 3L, electronic device 101 and/or pointing device 310 detects input 326, which can correspond to a double-contact such as a double-tapping of a finger on the housing of pointing device 310. In some examples, in response to detecting input 326, electronic device 101 can initiate display of a plurality of simulated tools that are available for the user's selection (e.g., to cause the selected to be presented and/or be the active simulated tool corresponding to pointing device 310). Additionally or alternatively, in response to detecting input 326, electronic device 101 can initiate a process to change the active simulated tool to be different from the current tool (e.g., different from the virtual rake), such as without presenting the plurality of available simulated tools. For example, in response to detecting input 326, electronic device 101 can change the active simulated tool to be a last-used simulated tool, and/or a simulated tool that a user of electronic device 101 indicated as a favorited simulated tool.

From FIG. 3L to FIG. 3M, pointing device 310 generates haptic feedback indicating that simulated tool 328 is the active tool. For example, in FIG. 3M, pointing device 310 generates a third haptic pattern, different from the first and/or second haptic patterns described above (e.g., “Pattern C”). In FIG. 3M, simulated tool 328 is a virtual brush which occupies a different region and/or volume in three-dimensional environment than the virtual rake. Accordingly, in FIG. 3M, region 334 of intersection between simulated tool 328 and volume 304b is different from the intersection between simulated tool 320 and volume 304b as described above. In particular, region 334 is smaller than the other region 322 because the virtual brush tip corresponds to a smaller volume than the virtual rake teeth. Similarly to as described above, the third haptic pattern can have one or more characteristics that are similar to, are the same as, or are different from the first and/or second haptic patterns. In FIG. 3M, electronic device 101 detects attention 330 directed to grabber 308 while hand 332 performs an air pinch gesture. In response to detecting attention 330 and/or hand 332, electronic device 101 can initiate movement of virtual object 302.

From FIG. 3M to FIG. 3N, electronic device 101 moves virtual object 302 relative to three-dimensional environment 300 in accordance with the movement of hand 332 (e.g., in a manner similar to, or the same as, described with reference to movement of a virtual object above based on air gesture movement). As described above, pointing device 310 can generate haptic feedback in accordance with the relative motion between virtual object 302 and the simulated tool 320. For example, from FIG. 3M to FIG. 3N, pointing device 310—and consequentially, simulated tool 320—is held static. Due to movement of virtual object 302, and because the simulated tool 320 continues to intersect with volume 304b from FIG. 3M to FIG. 3N, pointing device 310 can generate the haptic feedback. Thus, in a manner similar to physical objects moving with respect to one another, the tactile sensation simulated by pointing device 310 can be performed irrespectively of whether the relative motion between a virtual object and a simulated tool is caused by movement of the virtual object, movement of the simulated tool, and/or some combination thereof. For example, in FIG. 3N, pointing device 310 can generate the third haptic feedback pattern (e.g., the same haptic feedback that is generated when pointing device 310 moves through volume 304b while virtual object 302 remains static). Generating haptic feedback based on the relative motion of pointing device 310 and/or virtual object 302 (e.g., when pointing device 310 and/or virtual object 302 remain static) allows feedback to be generated by the movement of pointing device 310 and/or movement inputs directed to virtual object 302, allowing the degree of intersection, orientation, and/or position of pointing device 310 relative to virtual object 301 to be understood, optionally irrespective of whether pointing device 310 or virtual object 302 are moving in the three-dimensional environment.

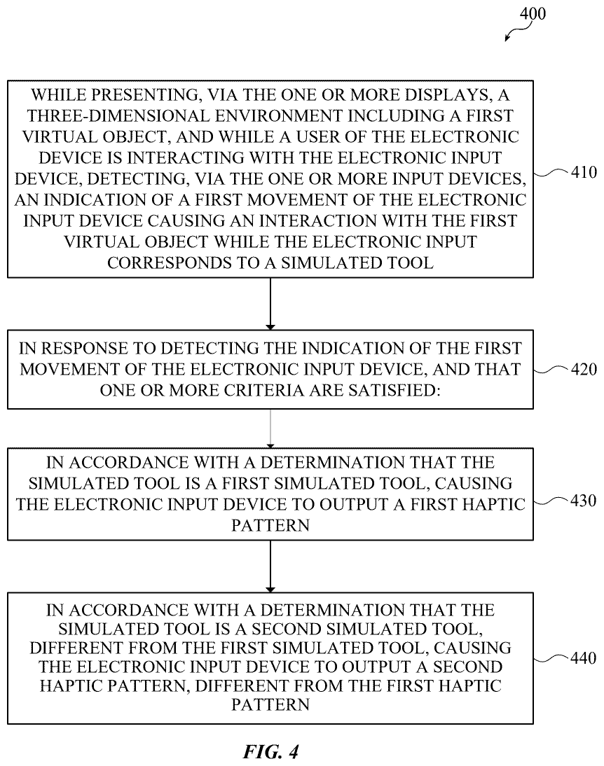

FIG. 4 illustrates an example flow diagram illustrating a method of generating haptic effects on an electronic pointing device based on virtual intersections according to some examples of the disclosure. In some examples, a method 400 can be performed by an electronic device. In some examples, the electronic device can be in communication with one or more input devices and a display. In some examples, while presenting a three-dimensional environment including a first virtual object, and while a user of the electronic device is interacting with an electronic pointing device, the electronic device can detect an indication of a first movement of the electronic device causing an interaction with the first virtual object while the electronic pointing device corresponds to a simulated tool. In response to detecting the indication of the first movement of the electronic pointing device, that one or more criteria are satisfied, and that the simulated tool is a first simulated tool, the electronic device can generate a first haptic pattern. In response to detecting the indication of the first movement of the electronic pointing device, that one or more criteria are satisfied, and that the simulated tool is a second simulated tool, the electronic device can generate a second haptic pattern.

In some examples, a method 400 can be performed at an electronic device in communication with one or more input devices and one or more displays, wherein the one or more input devices include an electronic pointing device. For example, the electronic device may be a head-mounted device, a wearable device, a headset, and/or glasses including and/or in communication with circuitry capable of causing displaying of virtual objects. In some examples, the one or more input devices includes one or more sensors capable of tracking one or more portions and/or features of a body of a user of the electronic device. For example, the one or more input devices optionally include electromagnetic sensors, gyroscopic sensors, acoustic sensors, optical sensors, and/or some combination thereof. The one or more input devices may track the position and/or spatial arrangement of physical portions of the user's body, such as the gaze of the user, the pose of one or more fingers, the movement of one or more fingers, the pose and/or movement of hands, forearms, and/or arms, and/or some combination thereof. In some examples, the one or more displays include one or more of a projected display capable of projecting images onto a surface, transparent or partially transparent materials such as glass and/or acrylics, light-emitting displays capable of displaying images, and/or some combination thereof.

In some examples, the one or more input devices includes one or more devices having a physical housing that is physically separate from a housing of the electronic device. For example, the electronic pointing device is optionally an oblong, optionally handheld or wearable device that may include one or more sensors (similar to or the same as sensors described herein) capable of tracking a position of the electronic pointing device relative to a three-dimensional environment of the user and/or relative to the electronic device. For brevity, the electronic pointing device is at times referred to herein as the pointing device.

In some examples, the pointing device includes circuitry similar to or the same as included in the electronic device. For example, the pointing device optionally includes one or more processors and/or memory storing instructions, which when executed by the one or more processors, cause the pointing device to perform one or more operations. As an example, the pointing device optionally detects, stores, transmits, and/or receives information relating to the position and/or movement of the pointing device. Additionally or alternatively, the one or more operations may include generating haptic feedback, causing vibration(s) of the pointing device. It is understood that examples described herein may reference the electronic device causing the pointing device to perform operations (e.g., by transmitting instructions and/or information to the pointing device), but that additional or alternative examples are contemplated, such as examples in which the pointing device determines and/or initiates generation of haptic feedback without receiving an express instruction from the electronic device to generate the haptic feedback.

In some examples, while presenting, via the one or more displays, a three-dimensional environment including a first virtual object, and while a user of the electronic device is interacting with the electronic pointing device, the electronic device detects (402), via the one or more input devices, an indication of a first movement of the electronic pointing device causing an interaction with the first virtual object while the electronic pointing device corresponds to a simulated tool. For example, the electronic device may display of virtual objects, such as one or more virtual windows corresponding to one or more user interfaces for software applications, one or more two-dimensional images, one or more virtual objects having simulated three-dimensional properties (e.g., height, depth, and/or width), and/or some combination thereof. In some examples, the first virtual object optionally is generated by a software application, such as a virtual sandbox including a representation of virtual sand and/or volumetric container for the sand. Additionally or alternatively, the first virtual object may include a miniature of a virtual scene, such as a virtual river and/or a virtual landscape.

In some examples, the movement of the electronic pointing device is detected by the electronic device. For example, the electronic device may use one or more of the above-described input devices to detect movement of the electronic pointing device relative to the three-dimensional environment, such as one or more cameras, one or more ultrasonic sensors, one or more capacitive sensors, and/or the like to track the position of the electronic pointing device. In some examples, the indication of movement additionally or alternatively includes data and/or information communicated from the electronic pointing device to the electronic device. For example, the electronic pointing device may independently track its position relative to the three-dimensional environment, and/or may transmit the information and/or the data describing its position (and/or its velocity and/or acceleration) to the electronic device. In some examples, the electronic device determines the location of the electronic pointing device relative to the three-dimensional environment using a combination of data and/or information detected and/or determined at the electronic device, and additionally using the data and/or the information received from the electronic pointing device.

In some examples, in response to detecting the indication of the first movement of the electronic pointing device, and that one or more criteria are satisfied, in accordance with a determination that the simulated tool is a first simulated tool, the electronic device generates (404) a first haptic pattern and/or causes the electronic pointing device to generate the first haptic pattern. In some examples, the electronic device generates and/or causes the electronic pointing device to generate haptic feedback in accordance with a determination that the simulated tool corresponding to the electronic pointing device intersects with a virtual object. As one example, the electronic device may detect that due to the first movement the electronic pointing device, a simulated tool extending from and/or corresponding to the location of the electronic pointing device begins to or continues to intersect with a virtual sandbox. In response to detecting the indication of the first movement, the electronic device may cause the electronic pointing device to fire a haptic pattern to simulate the sensation of a physical tool that corresponds to the simulated tool colliding, intersecting, and/or moving through a physical object that corresponds to the virtual object. In some examples, the one or more criteria may include a criterion that is satisfied when the electronic pointing device corresponds to a position within the three-dimensional environment that is within a threshold distance of the virtual object, and/or a criterion that is satisfied when the movement causes a position and/or volume that corresponds to the electronic pointing device to intersect with a position and/or volume that corresponds to the virtual object.

In some examples, the simulated tool mimics a comparable physical tool. For example, the simulated tool is optionally a simulated rake, pen, knife, shovel, utensil, and/or mallet. In some examples, the simulated tool corresponds to a virtual object that does not necessarily have a physical analogue, such as a magic wand, a beam of virtual light, and/or a fictitious armament. In some examples, the electronic device causes the electronic pointing device to generate the first haptic pattern to simulate an analogous physical interaction between a physical tool and a physical equivalent of the virtual object. For example, the electronic device can transmit one or more signals to the electronic pointing device, which can cause the electronic pointing device to initiate one or more haptics motors to generate haptic feedback at the electronic pointing device. In some examples, the electronic device can generate a haptic pattern in response to detecting the first movement of the electronic pointing device. It is understood that some examples described herein reference operations in which the electronic device generates a haptic pattern and/or haptic feedback. Similar or the same operations can be performed when the electronic device causes the electronic pointing device to generate the haptic pattern. For example, one or more examples described herein reference causing the electronic device to generate the first haptic pattern or a second haptic pattern in accordance with a determination the simulated tool corresponding to the electronic pointing device is a first simulated tool or a second simulated tool, respectively. It is understood that the electronic device additionally or alternatively can cause the electronic pointing device to generate the first haptic pattern or the second haptic pattern based upon whether the simulated tool corresponds to the first simulated tool or the second simulated tool. As described further below, the haptic pattern can be generated based on one or more characteristics of the virtual object that the simulated tool intersects.

In some examples, the haptic feedback includes the first haptic pattern. In some examples, the first haptic pattern is based upon the particular simulated tool that is associated with the pointing device, such as a simulated rake. In some examples, the first haptic pattern is additionally or alternatively based upon the virtual object that the first simulated tool is interacting with. For example, in response to detecting the indication of the first movement, the electronic device can determine the existence of a virtual collision between the simulated tool and the virtual object (e.g., when locations that the virtual tool virtually occupies at least partially intersect the locations that the virtual object virtually occupies). Based upon the properties of the simulated tool and the virtual object, such as a virtual texture of the virtual object, the electronic device can cause the pointing device to generate the haptic pattern simulating the sensation of analogous physical objects colliding and/or intersecting. For example, the electronic pointing device can generate haptic feedback simulating the sensation of a physical rake being dragged through a physical sandbox.

In some examples, the electronic device displays a representation of the simulated tool. For example, the electronic device optionally displays a virtual hammer, a virtual rake, a virtual pen nib, a virtual pen including a nib and a body, and/or some combination thereof. In some examples, the virtual tool extends along a dimension of a housing of the electronic pointing device. For example, the electronic device optionally displays a virtual rake having a cylindrical handle that extends from a body of the pointing device. As an example, the pointing device is optionally oblong, and the handle of the virtual rake is optionally parallel to a longitudinal axis of the pointing device. In some examples, the virtual location(s) that the virtual tool occupies include where the virtual tool is displayed, where the electronic pointing device is located, and/or a region surrounding one or more of the aforementioned locations.

In some examples, in response to detecting the indication of the first movement of the electronic pointing device, and in accordance with a determination that the simulated tool is a second simulated tool, different from the first simulated tool, the electronic device generates (406) a second haptic pattern, different from the first haptic pattern. For example, the generated second haptic pattern is different from the first haptic pattern to optionally simulate a different physical interaction between the second simulated tool and the virtual object. As one example, the electronic pointing device may correspond to a virtual metallic rod dragged through the virtual sandbox described above; accordingly, the second haptic pattern may simulate a smoother sensation and/or a lower amplitude of haptic feedback to better simulate the smoothness of the virtual metallic rod moving through sand. In some examples, the electronic device detects movement of the pointing device intersecting with and/or moving through a virtual grass field. In such examples, the electronic device may generate a third haptic pattern when the pointing device corresponds to a virtual spade, and may generate a fourth haptic pattern when the pointing device corresponds to a virtual paintbrush (e.g., the third and fourth haptic patterns are different from one another, and/or from the first and/or the second haptic patterns). In some examples, the second haptic pattern may include different amplitudes (e.g., higher or lower amplitudes) and/or different frequencies of haptic feedback, and/or different random or pseudo-random instances of haptic feedback generated over time during the movement of the pointing device, as compared to the first haptic pattern. In this way, the electronic device generates and/or causes the pointing device to generate haptic feedback to simulated virtual intersections between different simulated tools and/or different virtual objects (and/or portions such as a surface of the different virtual objects).

In some examples, the virtual object includes a virtual texture, and the first haptic pattern and the second haptic pattern are based upon one or more characteristics of the first virtual surface. For example, the virtual object may include one or more virtual surfaces and/or regions. In some examples, the surfaces and/or regions have simulated properties that are at least partial factors in determining the haptic feedback that is generated when the simulated tool intersects with the surfaces and/or regions. In some examples, the virtual texture of a portion of a virtual object includes one or more simulated properties, such as density, hardness, viscosity, elasticity, and/or the like. For example, the surfaces and/or regions optionally correspond to a patch of grass, a mound of dirt, a pile of sand, a piece of wood, a virtual region which does not have a physical analogue, a body of water, a patch of fabric, a head on a snare drum, and/or the like. In some examples, the surfaces and/or regions are associated with a simulated density. For example, virtual dirt is optionally less dense than a simulated piece of metal, simulated fabric is less dense than simulated sand, and/or the virtual region described above (e.g., a virtual window) is optionally less dense than a simulated region including water. In such examples, the haptic feedback varies based upon density. For example, a generated haptic pattern is optionally stronger in amplitude when a simulated tool moves through a high-density virtual surface and/or region than an amplitude of the haptic pattern generated when the simulated tool moves through a lower density virtual surface and/or region (or vice-versa). In some examples, the surfaces and/or regions are additionally associated with additional or alternative properties, such as a virtual hardness and/or a virtual elasticity. In some examples, the generated haptic feedback is determined in accordance with one or more of the aforementioned simulated properties, in some combination.

In some examples, while presenting, via the one or more displays, the three-dimensional environment including a second virtual object, the electronic device detects, via the one or more input devices, an indication of a second movement of the electronic pointing device causing an interaction with the second virtual object while the electronic device corresponds to the simulated tool. For example, the second virtual object may have one or more characteristics that are similar to or are the same as one or more characteristics of the first virtual object. In some examples, the indication of the second movement has one or more characteristics that are similar to or are the same as one or more characteristics of the indication of the first movement. In some examples, the interaction with the second virtual object has one or more characteristics that are similar to or are the same as one or more characteristics of the interaction between the simulated tool and the first virtual object.

In some examples, in response to detecting the indication of the second movement of the electronic pointing device (e.g., automatically, without detecting user input expressly requesting one or more of the operations described below), and in accordance with a determination that the simulated tool is the first simulated tool, generating a third haptic pattern. For example, the electronic device may generate and/or cause the electronic pointing device to generate haptic feedback based upon the active simulated tool (e.g., the first simulated tool) and the corresponding surface and/or region of the second virtual object that the simulated tool intersects with, in a manner similar to or the same as described above. For example, the electronic device may detect that the simulated rake moves through a virtual pool of water included in a volumetric second virtual object, and/or may generate a haptic pattern that is relatively lower amplitude, and/or is temporally more continuous than the haptic feedback generated when the simulated rake moves through virtual sand.

In some examples, in response to detecting the indication of the second movement of the electronic pointing device (e.g., automatically, without detecting user input expressly requesting one or more of the operations described below), and in accordance with a determination that the simulated tool is the second simulated tool, the electronic device generates a fourth haptic pattern, different from the third haptic pattern. For example, the electronic device may generate a haptic pattern that mimics the sensation of the virtual metallic rod described above being moved through the virtual pool of water.

In some examples, the electronic pointing device corresponds to a first volume in the three-dimensional environment when the electronic device corresponds to the simulated tool, and the first movement includes causing intersection between a first portion of the first volume and the first virtual object. For example, as described above, the electronic pointing device and/or the simulated tool may occupy one or more locations in the three-dimensional environment, similar to as though the electronic pointing device and/or the simulated tool occupied a physical region in the three-dimensional environment. In some examples, the electronic device detects that the one or more locations intersect and/or overlap with other location(s) that the virtual object occupy (e.g., the first volume), such as in response to detecting the first movement and/or the second movement of the electronic pointing device. In such examples, the electronic device may generate and/or cause the electronic pointing device to generate haptic feedback to simulate the sensation of an analogous physical intersection between a physical tool and a physical object. In some examples, in response to detecting the first movement, and in accordance with a determination that a virtual intersection between the first portion of the first volume and the first virtual object do not intersect, the electronic device forgoes (and/or ceases) generation of haptic feedback at the electronic pointing device.

In some examples, generating the first haptic pattern includes, in accordance with detecting a first degree of intersection between the first portion of the volume and the first virtual object, generating the first haptic pattern with a first haptic magnitude. For example, the magnitude of haptic feedback optionally includes one or more of the frequencies of waves generated, the amplitude of the waves, the temporal pattern such as the periodicity, the pseudo-randomness, and/or the concurrency of one or more of the waves, and/or additional or alternative factors that may change the physical sensation provided to a user that contacts the electronic pointing device. In some examples, because the degree of intersection corresponds to a first degree, the electronic device causes the electronic pointing device to generate a first haptic feedback pattern.

In some examples, generating the first haptic pattern includes, in accordance with detecting a second degree of intersection, different from the first degree of intersection, between the first portion of the volume and the first virtual object, generating the first haptic pattern with a second haptic magnitude, different from the first haptic magnitude. For example, the second haptic pattern and/or the magnitude of the second haptic pattern may be based upon the extent to which the simulated tool intersects with and/or overlaps with the virtual object. For example, in response to detecting movement of the electronic pointing device that increases the degree of overlap between the simulated tool and/or the virtual object, the electronic device optionally increases the magnitude of the haptic feedback. In response to detecting movement of the electronic pointing device that decreases the degree of overlap between the simulated tool and/or the virtual object, the electronic device optionally decreases the magnitude of the haptic feedback. For example, as the electronic pointing device corresponding to the simulated rake is pushed deeper into a pile of virtual sand, the amplitude of generated haptic feedback optionally increases. Additionally or alternatively, as the simulated rakes is pulled out of the pile of virtual sand, the amplitude of the generated haptic feedback optionally decreases. In some examples, in response to detecting movement of the electronic pointing device while the simulated tool intersects with the virtual object, and in accordance with a determination that the degree of intersection is maintained (e.g., the virtual rake is moved laterally with respect to the pile of sand, without changing the depth of the rake), the electronic device generates and/or causes the electronic pointing device to generate haptic feedback of a similar or same magnitude. In some examples, the magnitude of the haptic feedback saturates after the simulated tool overlaps by a certain degree with the virtual object. For example, when at least 75% of the simulated tool intersects with the virtual object, the electronic device may forgo increasing the magnitude of the haptic feedback, such as not increasing the magnitude when 80% or 90% of the simulated tool intersects with the virtual object.

In some examples, the electronic pointing device corresponds to a first volume in the three-dimensional environment when the electronic device corresponds to the simulated tool. For example, the first volume may have one or more characteristics similar to or the same as one or more characteristics of the first volume described above (e.g., the first volume is the volume that the virtual object occupies).

In some examples, in response to detecting the indication of a second movement of the electronic pointing device, different from the indication of the first movement, while the electronic pointing device corresponds to the simulated tool, and in accordance with a determination that the first volume and the first virtual object are not intersecting, the electronic device forgoes generating of the first haptic pattern and the second haptic pattern and/or forgoes transmitting a request for the electronic pointing device to generate the first and/or the second haptic pattern. For example, in response to detecting movement of the electronic pointing device that moves the simulated tool such that the simulated tool does not intersect with the first volume, the electronic device may forgo and/or cause the electronic pointing device to forgo generating of haptic feedback. For example, in response to detecting movement of the electronic pointing device that entirely pulls the displayed simulated tool out of the virtual sand described above, the electronic device ceases the generation and/or the causing of the generation of the haptic feedback. In some examples, in response to detecting movement of the electronic pointing device initiating and/or re-initiating intersection between the electronic pointing device and the first volume (e.g., the virtual object), the electronic device causes generation of third haptic pattern, different from the first and/or the second haptic pattern. In some examples, the third haptic pattern uniquely indicates the initiation of the intersection. For example, the third haptic pattern may include one or more rapid haptic pulses and/or patterns having magnitudes that may be greater than subsequent haptic feedback, to more clearly indicate that the intersection has initiated.

In some examples, generating the first haptic pattern includes, in accordance with detecting a first velocity of the simulated tool relative to the virtual object, generating the first haptic pattern with a first haptic magnitude, and in accordance with detecting a second velocity of the simulated tool relative to the virtual object, generating the first haptic pattern with a first haptic magnitude. For example, the generated haptic pattern and/or magnitude may be based upon a virtual velocity and/or acceleration of the electronic pointing device. In some examples, in accordance with a determination that the velocity of the electronic pointing device is a first velocity (and/or a first acceleration), the haptic pattern includes one or more first characteristics (e.g., amplitude, pattern, magnitude, combination of frequencies, and/or some combination thereof). In some examples, in accordance with a determination that the velocity of the electronic pointing device is a second velocity (and/or a second acceleration), the haptic pattern includes one or more second characteristics (e.g., amplitude, pattern, magnitude, combination of frequencies, and/or some combination thereof). For example, the haptic pattern optionally is more rapid and/or is relatively higher amplitude when the velocity (and/or acceleration) is higher, as compared to the haptic pattern generated when the velocity (and/or acceleration) is relatively lower, or vice-versa.

In some examples, in accordance with a determination that the indication of the first movement includes a first speed of movement, the first haptic pattern includes a first one or more characteristics. For example, in a manner similar to or the same as described above, the first series optionally includes a first periodicity, first one or more amplitudes, a first combination of haptic wave frequencies, and/or first temporal patterns of the haptic feedback.

In some examples, in accordance with a determination that the indication of the first movement includes a second speed of movement, less than the first speed of movement, the first haptic pattern includes a second one or more characteristics, different from the first one or more characteristics. For example, in a manner similar to or the same as described above, the second series optionally includes a second periodicity, second one or more amplitudes, a second combination of haptic wave frequencies, and/or second temporal patterns of the haptic feedback.

In some examples, the size of the simulated tool dictates the volume that the simulated tool occupies. In some examples, one or more characteristics of the generated haptic feedback are based upon the size and/or volume of the simulated tool. In some examples, in accordance with a determination that the simulated tool corresponds to a first volume relative to the three-dimensional environment when the indication of the first movement is detected, the first haptic pattern that is generated includes a first one or more characteristics. For example, the first haptic feedback has one or more characteristics similar to or the same as the series of haptic feedback described above. Thus, in some examples, the amplitude, wave frequency, the number of waves, the temporal pattern of waves, and/or some combination thereof are based upon the size of the virtual tool being a first volume. For example, the virtual rake described above may be occupy a first volume in the three-dimensional environment, and may virtually intersect to a first depth relative to the virtual sandbox and/or pile of sand described above when the indication of the first movement is detected. In response to detecting the indication of the first movement, the electronic device may generate and/or cause the electronic pointing device to generate the first series of haptic feedback, such as including a first magnitude of the haptic feedback.

In some examples, in accordance with a determination that the simulated tool corresponds to a second volume relative to the three-dimensional environment, different from than the first size, when the indication of the first movement is detected, the first haptic pattern includes second one or more characteristics, different from first series of haptic feedback. For example, the virtual rake described above may be occupy a second volume in the three-dimensional environment (e.g., greater than or less than the first volume), and may virtually intersect to the first depth relative to the virtual sandbox and/or pile of sand described above when the indication of the first movement is detected. In response to detecting the indication of the first movement, the electronic device may generate and/or cause the electronic pointing device to generate the second one or more characteristics, such as a different amplitude, temporal pattern, spatial arrangement, and/or the frequency of generated haptic feedback different from the first one or more characteristics.

In some examples, the orientation of the electronic pointing device while intersecting with the virtual objects is used to determine the haptic feedback that is generated to convey intersection between the virtual object and the simulated tool. In some examples, in accordance with a determination that the simulated tool has a first orientation relative to the first virtual object when the indication of the first movement is detected, the first haptic pattern includes a first series of haptic feedback. For example, relative to a first surface included in the virtual object, the simulated tool may have a first orientation while intersecting with the first surface. In such an example, while the first orientation is maintained, the indication of the first movement may be detected at the electronic device. In response to detecting the indication of the first movement, the electronic device may generate the first series of haptic feedback.

In some examples, in accordance with a determination that the simulated tool has a second orientation relative to the first virtual object when the indication of the first movement is detected, different from the first orientation, the first haptic pattern includes a second series of haptic feedback, different from the first series of haptic feedback. For example, relative to the first surface, the simulated tool may have a second orientation while intersecting with the first surface when the indication of the first movement is detected, the second orientation optionally different from the first orientation. In some examples, in response to detecting the indication of the first movement, the electronic device generates a second series of haptic feedback. For example, the haptic feedback may be lower or higher amplitude, may include different temporal patterns of waves, may include different combinations of concurrent generation of haptic waves, and/or some combination thereof. The first orientation, for example, may include the simulated tool being normal to the first surface. The second orientation, for example, may include the simulated tool being oblique to the first surface (e.g., intersecting, but not normal). In such examples, the electronic device may generate a relative stronger haptic feedback pattern while the simulated tool has the first orientation as compared to a relatively weaker haptic feedback pattern while the simulated tool has the second orientation (or vice-versa). Thus, the electronic device may generate haptic feedback that varies to indicate the orientation of the simulated tool relative to the virtual object (and/or the first surface).

In some examples, the one or more criteria include a criterion that is satisfied when a location corresponding to the simulated tool is within a volume in the three-dimensional environment associated with generating haptic feedback. In some examples, the electronic device generates and/or causes the electronic pointing device to generate haptic feedback in accordance with a determination that the electronic pointing device moves within a volume in the three-dimensional environment that is different from the volume that the virtual object occupies. For example, the virtual object may be associated with a haptic “zone” that surrounds the virtual object (e.g., corresponding to the volume associated with generating the haptic feedback). In some examples, a border corresponding to the region is displayed. In other examples, the border is not displayed. One example of such a region may include a region around a virtual drum that the simulated tool is able to strike. As the simulated tool, such as a virtual drumstick, moves enters the region, the electronic device may cause the electronic pointing device to generate the haptic feedback, indicating that the virtual drumstick has drawn close to the virtual drum, but may not have yet struck the virtual drum. In response to detecting the virtual drumstick intersect (e.g., virtually strike) the drum, the electronic device may cause the electronic pointing device to generate another haptic pattern and/or haptic feedback, different from the haptic feedback that was generated when the virtual drumstick passed into the region.

In some examples, while presenting the first virtual object within the three-dimensional environment, the electronic device detects, via the one or more input devices, one or more inputs requesting movement of the first virtual object. For example, the one or more inputs may requesting movement may include one or more of a voice command, concurrent attention (e.g., gaze) directed to a virtual handle while a user of the electronic device performs an air gesture (e.g., an air pinch including contacting of fingers, an air pointing including extending of one or more fingers, and/or an air curling of one or more fingers), and/or selection input detected at the electronic pointing device that is communicated to the electronic device (e.g., contact with a trackpad while a displayed cursor points to virtual object, selection of a physical or virtual button, and/or force applied to a housing of the electronic pointing device). In some examples, the inputs additionally or alternatively include movement of a joystick, a contact on a surface such as the housing and/or the trackpad, a voice command, and/or movement of the user's body while the air gesture is maintained. In some examples, the requested movement may be in one or more directions and/or by one or more distances that are similar to, the same as, and/or otherwise based upon the one or more directions and/or distances of movement of the input.

In some examples, in response to detecting the one or more inputs, the electronic device moves the first virtual object relative to the three-dimensional environment in accordance with the one or more inputs. For example, in response to detecting leftward movement of an air gesture, the electronic device may move the virtual object leftward relative to the user's position and/or orientation relative to the three-dimensional environment. In response to detecting rightward movement of the air gesture, the electronic device may move the virtual object rightward relative to the user's position and/or orientation relative to the three-dimensional environment. It is understood that the input and/or the affected virtual object movement may be along one or more axes defined relative to the three-dimensional environment and/or relative to the user's viewpoint.

In some examples, in accordance with a determination that the one or more criteria are satisfied, including a criterion that is satisfied when a first volume corresponding to the electronic pointing device virtually intersects with the first virtual object, the electronic device generates a third haptic pattern at the electronic pointing device. In some examples, as described above, the electronic device generates and/or causes the electronic pointing device to generate haptic feedback when the first virtual object and the simulated tool begin to intersect, such as in response to detecting the one or more inputs requesting the movement of the virtual object. In some examples, the electronic device additionally or alternatively generates haptic feedback in response to detecting input initiating the movement of the virtual object. For example, in response to detecting such input initiating movement, the electronic device may generate the haptic feedback, which may be different from the other haptic feedback patterns generated in other contexts. In some examples, the haptic feedback is generated independently of whether the virtual object intersects with the simulated tool. For example, the haptic feedback may be generated even while the volume corresponding to the virtual object does not overlap with the volume corresponding to the simulated tool.

In some examples, while the simulated tool is the first simulated tool, the electronic device and/or the electronic pointing device detect, via the one or more input devices, one or more inputs changing the simulated tool to correspond to the second simulated tool. For example, the electronic device may detect one or more inputs requesting changing of the simulated tool that corresponds to the electronic pointing device. In some examples, while displaying the simulated tool, the electronic device displays a selectable option near a portion of the simulated tool. For example, the selectable option may include a button, a graphic, an icon, text, and/or some combination thereof. In some examples, in response to detecting attention (e.g., gaze) of the user directed to the selectable option, and/or when additional or alternative input(s) are provided, the electronic device initiates a process to potentially change the active simulated tool (e.g., a contacting of a trackpad on the electronic pointing device, a squeezing of the housing on the electronic pointing device, a selection of a physical or virtual button, a voice command, and/or performance of an air gesture by a portion of the user's body). In some examples, the process includes displaying a user interface and/or user interface elements to select the active simulated tool. In some examples, the user interface includes a plurality of representation of available tools, such as at least a portion of a virtual shovel, a virtual pen, a virtual hammer, and/or other virtual tools described herein. In some examples, the electronic device detects inputs scrolling and/or moving through the available simulated tools, and in response to detecting the inputs, changes which available tools are represented (e.g., cycling through a plurality of available tools).

In some examples, in response to detecting the one or more inputs, the electronic device and/or the electronic pointing device change the simulated tool from the first simulated tool to the second simulated tool. In some examples, in response to detecting input directed toward one of the representations of the tools, the electronic device ceases display of the user interface and/or the representation of the tools, and replaces display of the previously active simulated tool with the selected simulated tool. For example, when the virtual rake is displayed and the user interface to selecting the simulated tool is invoked, the electronic device may detect the user select a representation of the virtual hammer. In response to detecting the selection of the virtual hammer, the electronic device may cease display of the virtual rake extending from the electronic pointing device, and may initiate display of the virtual hammer extending from the electronic pointing device.

FIG. 4 illustrates an example flow diagram illustrating a method of generating haptic effects on an electronic pointing device based on virtual intersections according to some examples of the disclosure. Method 400 is directed to causing an electronic input device to generate a haptic pattern. In some examples, method 400 includes, while presenting, via the one or more displays, a three-dimensional environment including a first virtual object, and while a user of the electronic device is interacting with the electronic input device, detecting (at step 410), via the one or more input devices, an indication of a first movement of the electronic input device causing an interaction with the first virtual object while the electronic input device corresponds to a simulated tool. In some examples, method 400 includes, in response to detecting the indication of the first movement of the electronic input device, and that one or more criteria are satisfied (at step 420), in accordance with a determination that the simulated tool is a first simulated tool, causing (at step 430) the electronic input device to output a first haptic pattern. In some examples, method 400 includes, in accordance with a determination that the simulated tool is a second simulated tool, different from the first simulated tool, causing the electronic input device to output a second haptic pattern, different from the first haptic pattern (at step 440).

In some examples, the first virtual object includes a virtual texture, and the first haptic pattern and the second haptic pattern are based upon one or more characteristics of the virtual texture. In some examples, method 400 further comprises, while presenting, via the one or more displays, the three-dimensional environment including a second virtual object, detecting, via the one or more input devices, an indication of a second movement of the electronic input device causing an interaction with the second virtual object while the electronic input device corresponds to the simulated tool; and in response to detecting the indication of the second movement of the electronic input device: in accordance with a determination that the simulated tool is the first simulated tool, causing the electronic input device to output a third haptic pattern; and in accordance with a determination that the simulated tool is the second simulated tool, causing the electronic input device to output a fourth haptic pattern, different from the third haptic pattern. In some examples, the electronic input device corresponds to a first volume in the three-dimensional environment when the electronic input device corresponds to the simulated tool, and the first movement causes intersection between a first portion of the first volume and the first virtual object. In some examples, in accordance with detecting a first degree of intersection between the first portion of the first volume and the first virtual object, the first haptic pattern includes a first haptic magnitude; and in accordance with detecting a second degree of intersection, different from the first degree of intersection, between the first portion of the first volume and the first virtual object, the first haptic pattern includes a second haptic magnitude, different from the first haptic magnitude. In some examples, the electronic input device corresponds to a first volume in the three-dimensional environment when the electronic input device corresponds to the simulated tool. In some examples, the method 400 further comprises, in response to detecting the indication of a second movement of the electronic input device, different from the indication of the first movement, while the electronic input device corresponds to the simulated tool, and in accordance with a determination that the first volume and the first virtual object are not intersecting, forgoing causing the electronic input device to output the first haptic pattern and the second haptic pattern. In some examples, in accordance with detecting a first velocity of the simulated tool relative to the first virtual object, the first haptic pattern includes a first haptic magnitude, and in accordance with detecting a second velocity of the simulated tool relative to the first virtual object, the first haptic pattern includes a second haptic magnitude. In some examples, in accordance with a determination that the first velocity includes a first speed of movement, the first haptic pattern includes the first haptic magnitude; and in accordance with a determination that the first velocity includes a second speed of movement, less than the first speed of movement, the first haptic pattern includes the second haptic magnitude. In some examples, in accordance with a determination that the simulated tool corresponds to a first volume relative to the three-dimensional environment when the indication of the first movement is detected, the first haptic pattern includes a first haptic magnitude; and in accordance with a determination that the simulated tool corresponds to a second volume relative to the three-dimensional environment, different from than the first volume, when the indication of the first movement is detected, the first haptic pattern includes a second haptic magnitude, different from haptic magnitude. In some examples, in accordance with a determination that the simulated tool has a first orientation relative to the first virtual object when the indication of the first movement is detected, the first haptic pattern includes a first series of haptic feedback, and in accordance with a determination that the simulated tool has a second orientation relative to the first virtual object when the indication of the first movement is detected, different from the first orientation, the first haptic pattern includes a second series of haptic feedback, different from the first series of haptic feedback. In some examples, the one or more criteria include a criterion that is satisfied when a location corresponding to the simulated tool is within a volume in the three-dimensional environment associated with generating haptic feedback. In some examples, method 400 further comprises, while presenting the first virtual object within the three-dimensional environment, detecting, via the one or more input devices, one or more inputs requesting movement of the first virtual object; and in response to detecting the one or more inputs, moving the first virtual object relative to the three-dimensional environment in accordance with the one or more inputs; and in accordance with a determination that the one or more criteria are satisfied, including a criterion that is satisfied when a first volume corresponding to the electronic input device virtually intersects with the first virtual object, generating a third haptic pattern at the electronic input device. In some examples, method 400 further comprises while the simulated tool is the first simulated tool, detecting, via the one or more input devices, one or more inputs changing the simulated tool to correspond to the second simulated tool; and in response to detecting the one or more inputs, changing the simulated tool from the first simulated tool to the second simulated tool.

Some examples of the disclosure are directed to an electronic device comprising: one or more displays, one or more input devices, memory, one or more processors, and one or more programs, wherein the one or more programs are stored in the memory and are configured to be executed by the one or more processors, the one or more programs including instructions for: while presenting, via the one or more displays, a three-dimensional environment including a first virtual object, and while a user of the electronic device is interacting with an electronic input device, detecting, via the one or more input devices, an indication of a first movement of the electronic input device causing an interaction with the first virtual object while the electronic input device corresponds to a simulated tool; in response to detecting the indication of the first movement of the electronic input device, and that one or more criteria are satisfied: in accordance with a determination that the simulated tool is a first simulated tool, causing the electronic input device to output a first haptic pattern; and in accordance with a determination that the simulated tool is a second simulated tool, different from the first simulated tool, causing the electronic input device to output a second haptic pattern, different from the first haptic pattern.

Some examples of the disclosure are directed to a non-transitory computer readable storage medium. The non-transitory computer readable storage medium storing instructions, which when executed by an electronic device in communication with one or more input devices and one or more displays, wherein the one or more input devices include an electronic input device, cause the electronic device to: while presenting, via the one or more displays, a three-dimensional environment including a first virtual object, and while a user of the electronic device is interacting with the electronic input device, detect, via the one or more input devices, an indication of a first movement of the electronic input device causing an interaction with the first virtual object while the electronic input device corresponds to a simulated tool; in response to detecting the indication of the first movement of the electronic input device, and that one or more criteria are satisfied: in accordance with a determination that the simulated tool is a first simulated tool, causing the electronic input device to output a first haptic pattern; and in accordance with a determination that the simulated tool is a second simulated tool, different from the first simulated tool, causing the electronic input device to output a second haptic pattern, different from the first haptic pattern.

Some examples of the disclosure are directed to an electronic input device, wherein the electronic input device comprises: one or more sensors, wherein the one or more sensors are configured to detect inputs directed to the electronic input device; a haptic feedback engine, wherein the haptic feedback engine is configured to generate a haptic feedback at the electronic input device; one or more processors; memory; and one or more programs, wherein the one or more programs are stored in the memory and configured to be executed by the one or more processors, the one or more programs including instructions for: while the electronic input device is in communication with an electronic device presenting a three-dimensional environment including virtual content: receiving an indication to output haptic feedback via the haptic feedback engine in accordance with an intersection between a simulated tool that corresponds to the electronic input device with the virtual content; and in response to receiving the indication, and in accordance with a determination that the simulated tool is a first simulated tool, outputting a first haptic pattern; and in response to receiving the indication, and in accordance with a determination that the simulated tool is a second simulated tool, different from the first simulated tool, outputting a second haptic pattern, different from the first haptic pattern. In some examples, the virtual content includes a virtual texture, and the first haptic pattern and the second haptic pattern are based upon one or more characteristics of the virtual texture. In some examples, in accordance with a determination that a velocity of the simulated tool is a first velocity when the intersection is detected, the first haptic pattern includes a first haptic magnitude, and in accordance with a determination that the velocity of the simulated tool is a second velocity when the intersection is detected, the first haptic pattern includes a second haptic magnitude, different from the first haptic magnitude. In some examples, in accordance with a determination that the simulated tool occupies a first volume in the three-dimensional environment when the intersection is detected, the first haptic pattern includes a first haptic magnitude, and in accordance with a determination that the simulated tool occupies a second volume in the three-dimensional environment when the intersection is detected, the first haptic pattern includes a second haptic magnitude, different from the first haptic magnitude. In some examples, the one or more processors are further configured to cause the electronic input device to: detect, via the one or more sensors, touch input directed to circuitry included in the electronic input device, transmit an indication of the touch input to the electronic device, wherein the indication corresponds to a changing of a characteristic of the simulated tool that corresponds to the electronic input device, after transmitting the indication of the touch input, receiving an additional indication to output haptic feedback via the haptic feedback engine in accordance with the intersection between the simulated tool and the virtual content, and outputting a third haptic pattern, different from the first haptic pattern and the second haptic pattern, based upon the additional indication.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the disclosure and its practical applications, to thereby enable others skilled in the art to best use the disclosure and various described examples with various modifications as are suited to the particular use contemplated.

What is claimed is:

1. A method comprising:
at an electronic device in communication with one or more input devices and one or more displays, wherein the one or more input devices include an electronic input device:
while presenting, via the one or more displays, a three-dimensional environment including a first virtual object, and while a user of the electronic device is interacting with the electronic input device, detecting, via the one or more input devices, an indication of a first movement of the electronic input device causing an interaction with the first virtual object while the electronic input device corresponds to a simulated tool;
in response to detecting the indication of the first movement of the electronic input device, and that one or more criteria are satisfied:
in accordance with a determination that the simulated tool is a first simulated tool, causing the electronic input device to output a first haptic pattern; and
in accordance with a determination that the simulated tool is a second simulated tool, different from the first simulated tool, causing the electronic input device to output a second haptic pattern, different from the first haptic pattern.

2. The method of claim 1, wherein the first virtual object includes a virtual texture, and the first haptic pattern and the second haptic pattern are based upon one or more characteristics of the virtual texture.

3. The method of claim 1, wherein the electronic input device corresponds to a first volume in the three-dimensional environment when the electronic input device corresponds to the simulated tool, and the first movement causes intersection between a first portion of the first volume and the first virtual object.

4. The method of claim 1, wherein the electronic input device corresponds to a first volume in the three-dimensional environment when the electronic input device corresponds to the simulated tool, the method further comprising:
in response to detecting the indication of a second movement of the electronic input device, different from the indication of the first movement, while the electronic input device corresponds to the simulated tool, and in accordance with a determination that the first volume and the first virtual object are not intersecting, forgoing causing the electronic input device to output the first haptic pattern and the second haptic pattern.

5. The method of claim 1, wherein:
in accordance with detecting a first velocity of the simulated tool relative to the first virtual object, the first haptic pattern includes a first haptic magnitude, and
in accordance with detecting a second velocity of the simulated tool relative to the first virtual object, the first haptic pattern includes a second haptic magnitude.

6. The method of claim 1, wherein:
in accordance with a determination that the simulated tool has a first orientation relative to the first virtual object when the indication of the first movement is detected, the first haptic pattern includes a first series of haptic feedback, and
in accordance with a determination that the simulated tool has a second orientation relative to the first virtual object when the indication of the first movement is detected, different from the first orientation, the first haptic pattern includes a second series of haptic feedback, different from the first series of haptic feedback.

7. The method of claim 1, further comprising:
while presenting the first virtual object within the three-dimensional environment, detecting, via the one or more input devices, one or more inputs requesting movement of the first virtual object; and
in response to detecting the one or more inputs:
moving the first virtual object relative to the three-dimensional environment in accordance with the one or more inputs; and
in accordance with a determination that the one or more criteria are satisfied, including a criterion that is satisfied when a first volume corresponding to the electronic input device virtually intersects with the first virtual object, generating a third haptic pattern at the electronic input device.

8. An electronic device comprising:
one or more displays;
one or more input devices;
memory;
one or more processors; and
one or more programs, wherein the one or more programs are stored in the memory and are configured to be executed by the one or more processors, the one or more programs including instructions for:
while presenting, via the one or more displays, a three-dimensional environment including a first virtual object, and while a user of the electronic device is interacting with an electronic input device, detecting, via the one or more input devices, an indication of a first movement of the electronic input device causing an interaction with the first virtual object while the electronic input device corresponds to a simulated tool;
in response to detecting the indication of the first movement of the electronic input device, and that one or more criteria are satisfied:
in accordance with a determination that the simulated tool is a first simulated tool, causing the electronic input device to output a first haptic pattern; and
in accordance with a determination that the simulated tool is a second simulated tool, different from the first simulated tool, causing the electronic input device to output a second haptic pattern, different from the first haptic pattern.

9. The electronic device of claim 8, wherein the first virtual object includes a virtual texture, and the first haptic pattern and the second haptic pattern are based upon one or more characteristics of the virtual texture.

10. The electronic device of claim 8, wherein the electronic input device corresponds to a first volume in the three-dimensional environment when the electronic input device corresponds to the simulated tool, and the first movement causes intersection between a first portion of the first volume and the first virtual object.

11. The electronic device of claim 8, wherein the electronic input device corresponds to a first volume in the three-dimensional environment when the electronic input device corresponds to the simulated tool, the one or more programs further including instructions for:
in response to detecting the indication of a second movement of the electronic input device, different from the indication of the first movement, while the electronic input device corresponds to the simulated tool, and in accordance with a determination that the first volume and the first virtual object are not intersecting, forgoing causing the electronic input device to output the first haptic pattern and the second haptic pattern.

12. The electronic device of claim 8, wherein:
in accordance with detecting a first velocity of the simulated tool relative to the first virtual object, the first haptic pattern includes a first haptic magnitude, and
in accordance with detecting a second velocity of the simulated tool relative to the first virtual object, the first haptic pattern includes a second haptic magnitude.

13. The electronic device of claim 8, wherein:
in accordance with a determination that the simulated tool has a first orientation relative to the first virtual object when the indication of the first movement is detected, the first haptic pattern includes a first series of haptic feedback, and
in accordance with a determination that the simulated tool has a second orientation relative to the first virtual object when the indication of the first movement is detected, different from the first orientation, the first haptic pattern includes a second series of haptic feedback, different from the first series of haptic feedback.

14. The electronic device of claim 8, the one or more programs further including instructions for:
while presenting the first virtual object within the three-dimensional environment, detecting, via the one or more input devices, one or more inputs requesting movement of the first virtual object; and
in response to detecting the one or more inputs:
moving the first virtual object relative to the three-dimensional environment in accordance with the one or more inputs; and
in accordance with a determination that the one or more criteria are satisfied, including a criterion that is satisfied when a first volume corresponding to the electronic input device virtually intersects with the first virtual object, generating a third haptic pattern at the electronic input device.

15. A non-transitory computer readable storage medium storing instructions, which when executed by an electronic device in communication with one or more input devices and one or more displays, wherein the one or more input devices include an electronic input device, cause the electronic device to:
while presenting, via the one or more displays, a three-dimensional environment including a first virtual object, and while a user of the electronic device is interacting with the electronic input device, detect, via the one or more input devices, an indication of a first movement of the electronic input device causing an interaction with the first virtual object while the electronic input device corresponds to a simulated tool;
in response to detecting the indication of the first movement of the electronic input device, and that one or more criteria are satisfied:
in accordance with a determination that the simulated tool is a first simulated tool, cause the electronic input device to output a first haptic pattern; and
in accordance with a determination that the simulated tool is a second simulated tool, different from the first simulated tool, cause the electronic input device to output a second haptic pattern, different from the first haptic pattern.

16. The non-transitory computer readable storage medium of claim 15, wherein the first virtual object includes a virtual texture, and the first haptic pattern and the second haptic pattern are based upon one or more characteristics of the virtual texture.

17. The non-transitory computer readable storage medium of claim 15, wherein the electronic input device corresponds to a first volume in the three-dimensional environment when the electronic input device corresponds to the simulated tool, the instructions when executed by the electronic device further cause the electronic device to:
in response to detecting the indication of a second movement of the electronic input device, different from the indication of the first movement, while the electronic input device corresponds to the simulated tool, and in accordance with a determination that the first volume and the first virtual object are not intersecting, forgo causing the electronic input device to output the first haptic pattern and the second haptic pattern.

18. The non-transitory computer readable storage medium of claim 15, wherein:
in accordance with detecting a first velocity of the simulated tool relative to the first virtual object, the first haptic pattern includes a first haptic magnitude, and
in accordance with detecting a second velocity of the simulated tool relative to the first virtual object, the first haptic pattern includes a second haptic magnitude.

19. The non-transitory computer readable storage medium of claim 15, wherein:
in accordance with a determination that the simulated tool has a first orientation relative to the first virtual object when the indication of the first movement is detected, the first haptic pattern includes a first series of haptic feedback, and
in accordance with a determination that the simulated tool has a second orientation relative to the first virtual object when the indication of the first movement is detected, different from the first orientation, the first haptic pattern includes a second series of haptic feedback, different from the first series of haptic feedback.

20. The non-transitory computer readable storage medium of claim 15, the instructions when executed by the electronic device further cause the electronic device to:
while presenting the first virtual object within the three-dimensional environment, detect, via the one or more input devices, one or more inputs requesting movement of the first virtual object; and
in response to detecting the one or more inputs:
move the first virtual object relative to the three-dimensional environment in accordance with the one or more inputs; and
in accordance with a determination that the one or more criteria are satisfied, including a criterion that is satisfied when a first volume corresponding to the electronic input device virtually intersects with the first virtual object, generate a third haptic pattern at the electronic input device.
